(19) United States
(12) Patent Application Publication
(10) Pub. No.: US 2009/0192861 A1
(43) Pub. Date: Jul. 30, 2009

(54) Client Apparatus, Server Apparatus, Meeting Arrangement System, and Meeting Arrangement Method

(76) Inventors: Hirotaka SUZUKI, Kanagawa (JP); Hideki Shimomura, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/361,454

(22) Filed: Jan. 28, 2009

(30) Foreign Application Priority Data
Jan. 30, 2008 (JP) P2008-018919

(51) Int. Cl. G06Q 10/00

(52) U.S. Cl. 705/8

(57) ABSTRACT

Disclosed is a client apparatus including a communication unit, a first generator to generate friendship information indicating a friendship between a first user of the client apparatus and each of second users of the plurality of other client apparatuses, a storage unit to store schedule information and meeting history information, a second generator to generate desired meeting date/time information of the first user, a third generator to generate desired meeting place information of the first user, a fourth generator to generate meeting member candidate information, and a controller to control the communication unit to transmit, to the server apparatus, the desired meeting date/time information, the desired meeting place information, and the meeting member candidate information.

### CROSS REFERENCES TO RELATED APPLICATIONS

The present invention contains subject matter related to Japanese Patent Application JP 2008-018919 filed in the Japanese Patent Office on Jan. 30, 2008, the entire contents of which being incorporated herein by reference.

### BACKGROUND OF THE INVENTION

1. Field of the Invention

The present invention relates to a client apparatus, a server apparatus, a meeting arrangement system, and a meeting arrangement method capable of automatically arranging a meeting for the purpose of private exchanges such as a drinking party.

2. Description of the Related Art

In related art, for example, Japanese Patent Application Laid-open No. 2005-141755 and Japanese Patent Application Laid-open No. 2007-122199 (hereinafter, referred to as Patent Documents 1 and 2, respectively) each disclose a system capable of automatically arranging a meeting schedule.

Patent Document 1 discloses a system in which, based on dates and times suggested by a server of an organizer of a meeting, clients each submit a preference with reference to his/her own schedule, and then the server coordinates the preferences of the clients to determine the meeting schedule.

Patent Document 2 discloses a meeting reservation apparatus having a function of extracting a date, as a candidate date when a meeting can be held, that exert the least influence on a project to which meeting participants belong, when making a reservation of the meeting based on schedule information of the meeting participants.

### SUMMARY OF THE INVENTION

In a case, for example, where a private meeting such as a drinking party and a party is arranged, users variously, arbitrarily have demands regarding a date, a place, participants, and so on. In contrast, there is also a case where users do not have detailed demands particularly.

Specifically, for example, there is a case where a user A wants users B and C to make sure to join a drinking party to be held, the user B hopes to drink with those the user B has not seen for quite some time, and the user C does not want to join the drinking party.

However, in the technique disclosed in Patent Document 1, a server suggests dates and times. This means that schedules of clients are restricted within the suggested range, and therefore clients' demands are not met by the suggestion only.

Further, in a case of arranging a private meeting, it may be inconvenience to arrange the meeting on certain dates and times based on implicit understanding or for a usual reason, even when there is no plan in schedule information of participants. For example, it may be inconvenient for some users to arrange the meeting on weeknights except Friday night.

However, as in the technique disclosed in Patent Document 2, in a case where the meeting is arranged based on the schedule information of the participants, it is of course difficult to meet demands of participants that are not included in the schedule information.

Accordingly, in related art, an organizer has to get the demands of the participants together and coordinate them to arrange the private meeting, which imposes a heavy burden on the organizer. In addition, arranging the meeting is a cumbersome task, so the meeting is less frequently arranged, which hinders active exchanges between persons.

In view of the above-mentioned circumstances, it is desirable to provide a client apparatus, a server apparatus, a meeting arrangement system, and a meeting arrangement method capable of reducing the burden on the organizer who arranges the private meeting having a high arrangement flexibility, and activating private exchanges between persons.

According to an embodiment of the present invention, there is provided a client apparatus, including: a communication means for communicating with a server apparatus and a plurality of other client apparatuses; a first generation means for generating, based on communication history information with the plurality of other client apparatuses by the communication means, friendship information indicating a friendship between a first user of the client apparatus and each of second users of the plurality of other client apparatuses; a storage means for storing schedule information including scheduled date/time information and scheduled place information of a scheduled event for the first user and meeting history information including date/time history information, place history Information, and member history information of a meeting arranged in a past; a second generation means for generating desired meeting date/time information of the first user based on the scheduled date/time information and the date/time history information stored; a third generation means for generating desired meeting place information of the first user based on the scheduled place information stored, the place history information stored, and desired meeting date/time information generated; a fourth generation means for generating meeting member candidate information indicating candidates of client apparatuses to be meeting members based on the friendship information generated; and a control means for controlling the communication means to transmit, to the server apparatus, the desired meeting date/time information, the desired meeting place information, and the meeting member candidate information generated as desired meeting information, and controlling the communication means to receive arranged meeting information arranged by the server apparatus based on the desired meeting information transmitted.

Here, the client apparatus refers to various kinds of electronic apparatuses such as a portable apparatus including a mobile phone, a PDA (personal digital assistant), a laptop PC (personal computer), and a desktop PC and AV (audiovisual) equipment. The meeting refers to a private event gathering multiple persons together such as a drinking party and a party. The communication history information refers to a phone-call history and an e-mail transmission/reception history. The date/time history information may include information on a date, a time, and a day of a week.

With this structure, only by generating the desired meeting date/time information, the desired meeting place information, and the meting member candidate information and transmitting them to the server apparatus, a meeting that satisfies the users' desire can be automatically set even when flexibility of arranging a date and a time, a place, members, and so on is high like a case of a drinking party. Therefore, a burden imposed on the organizer of the meeting can be significantly alleviated. Further, relations with acquaintances can be continued, deepened, or broadened without requiring a task of directly communicating with the acquaintances by phone calls or the like.

In the client apparatus, the storage means stores a communication count and a communication time with the plurality of other client apparatuses as the communication history information. The first generation means includes means for calculating a friendship frequency between the client apparatus and each of the other client apparatuses by assigning a first weighting factor to a first communication count in an off-duty period of the first user and assigning a second weighting factor smaller than the first weighting factor to a second communication count in an on-duty period, out of the communication count in a first predetermined period with the plurality of other client apparatuses, and means for calculating a rate of a friendship frequency with the plurality of other client apparatuses targeted for the calculation of the friendship frequency with respect to a sum of the friendship frequency with each of the other client apparatuses, the rate of the friendship frequency being calculated as a friendship degree between the first user and the second user. The control means controls the communication means to transmit, to the server apparatus, the friendship degree calculated for each of the plurality of other client apparatuses as a part of the friendship information.

Here, the on-duty period refers to, for example, 8 a.m. to 5 p.m. and the off-duty period refers to, for example, 5 p.m. to 8 a.m. next day, but they are not limited thereto. When the sum of the first weighting factor and the second weighting factor is set to 1.0, the first weighting factor becomes, for example, about 0.7 to 0.8, but is not limited thereto and may have 1.0 (the second weighting factor becomes 0). Further, the friendship degree is calculated from the friendship frequency because the total number of the other client apparatuses as friendship targets differs depending on each client apparatus. The predetermined first period refers to a period of, for example, a week, a month, and half a year.

Generally, communications with private friends and acquaintances are often performed in the off-duty period. Therefore, by calculating the friendship frequency and the friendship degree with the weighting factor of the off-duty period is set to a larger value than the on-duty period with the above-mentioned structure, with the result that the friendship degree of other client apparatuses having a higher communication frequency in the off-duty period can be set to be higher. By transmitting the friendship degree to the server apparatus, the server apparatus can determine private meeting members more appropriately.

In the client apparatus, the storage means stores a plurality of rule information items regarding a date and a time when the first user is capable of participating in the meeting. The second generation means includes means for comparing the date/time history information stored with the plurality of rule information items, means for determining, based on a result of the comparing, a rule information item having highest similarity to the meeting history information as estimation rule information and estimating the date and time when the first user is capable of participating in the meeting based on the estimation rule information, means for comparing the date and time estimated with the scheduled date/time information stored, and means for generating, based on a result of the comparing, a date and a time unmatched with the scheduled date/time information as the desired meeting date/time information.

With this structure, through matching operation of the rule information items and the date/time history information, rule information most close to a habit of a used of the client apparatus, and a date and a time when the user can participate based on the rule information. Accordingly, the desired meeting date/time information more matched with the habit of the user can be generated. Further, by excluding dates and times included in the scheduled date/time information from the estimated dates and times, a meeting to be arranged can be prevented from coinciding with another event of the user.

In the client apparatus, the second generation means sets, in a membership function in which an abscissa axis represents dates and times and an longitudinal axis represents membership values, the plurality of rule information items as a first fuzzy set and the date/time history information as a second fuzzy set, calculates an equivalence of the first fuzzy set and the second fuzzy set, determines a rule information item having a largest area of a third fuzzy set as a result of calculation of the equivalence, to be the estimation rule information.

By using the fuzzy logic operation, an event that is vague and allowed to range in number to some extent, e.g., “after x o'clock”, can be quantified. Therefore, by comparing the rule information items with the date/time history information through the fuzzy logic operation, non-uniform users' habits is quantified and the estimation rule information as close to the desire of the users as possible is determined, making it possible to generate the desired meeting date/time information as close to the desire of the users as possible.

In the client apparatus, the second generation means includes means for learning the date/time history information stored and estimating, based on a result of the learning, a date and a time when the first user is capable of participating in the meeting, means for comparing the date and time estimated with the scheduled date/time information stored, and means for generating, based on a result of the comparing, a date and a time unmatched with the scheduled date/time information as the desired meeting date/time information.

With this structure, by performing machine learning based on the date/time history information, the desired meeting date/time can be automatically estimated. Here, as the learning method, a hidden Markov model, a recurrent neural network, or the like can be used, but the method is not limited thereto.

In the client apparatus, the third generation means includes means for determining, based on the scheduled place information, a scheduled place of a scheduled event just before a date and a time included in the desired meeting information generated, to be a movement original position of the meeting, and means for generating, as the desired meeting place information, a distance range from the movement original position determined that is capable of being tolerated by the first user based on arranged place information and movement original position information of past meetings included in the place history information.

With this structure, the tolerable movement distance range information is calculated based on the distances actually moved for participating in the past meetings by the user, and therefore it can be prevented that the meeting place is arranged to a place where the user cannot actually move from the movement original position. In a case where there are a plurality of arranged place information items of the past meetings, an average value of distances from the movement original position to the arranged place (movement distances) in the meetings is set as the tolerable movement distance range.

In this case, the third generation means generates, as the tolerable movement distance range information, a tolerance function in which a first tolerance is assigned to positional coordinates existing in the tolerable movement distance range from the movement original position determined and a second tolerance smaller than the first tolerance is assigned to positional coordinates existing in a predetermined distance range out of the tolerable movement distance range.

Here, the first tolerance is set to 1.0, for example. The second tolerance is set so as to gradually become smaller between 1.0 and 0, with increasing distance from the tolerable movement distance range. As a result, even in a case of being outside of the tolerable movement distance range, by assigning the second tolerance, it can be prevented that the desired meeting place is uniformly determined based on the place history information.

In the client apparatus, the fourth generation means generates the meeting member candidate information by performing a weighted random selection such that other client apparatuses having a lower friendship frequency calculated are more highly weighted, to select the other client apparatuses.

With this structure, as acquaintances less frequently made contact with by the user in the near past, a possibility becomes higher in that the acquaintances are arranged as the meeting members. Therefore, a long time interval between meetings can be prevented, and becoming estranged from the acquaintances can also be prevented. In addition, generally, it is bothersome to make contact with acquaintances with whom the user less frequently meets. However, according to the present invention, the bother is eliminated and a meeting with the acquaintances can be arranged. Furthermore, unpredictability, freshness, or the like can be created.

In the client apparatus, the fourth generation means generates, based on the meeting history information, the meeting member candidate information by performing a weighted random selection such that other client apparatuses that have been set as the meeting member in a second predetermined period smaller number of times is more highly weighted, to select the other client apparatuses.

With this structure, as persons less frequently participate in the meetings in the near past, a possibility becomes higher in that the persons are arranged as the meeting members. Therefore, a long time interval between the meetings can be prevented, and fixation of the meeting members can be also prevented. The predetermined second period refers to a month, half a year, and a year, for example.

In the client apparatus, the storage means stores message information of an e-mail transmitted to/received from the other client apparatuses through the communication means. The fourth generation means includes means for judging whether a predetermined event has occurred for the other client apparatuses as a transmission/reception target of the message information by analyzing the message information, and means for generating, when it is judged that the predetermined event has occurred, the meeting member candidate information by performing a weighted random selection such that the other client apparatuses to which the predetermined event has occurred is highly weighted, to select the other client apparatuses.

Here, the predetermined event refers to such an event that the first user is motivated to meet the second user, e.g., a celebratory occasion such as marriage and childbirth, and a worry regarding a business or a private matter. With this structure, it is possible to automatically set another client apparatus having high necessity to meet with to the meeting member, which can arrange a more meaningful meeting.

The client apparatus further includes an operation input means through which the first user inputs an operation. In the client apparatus, the first generation means includes means for classifying the plurality of other client apparatuses into a plurality of attributes according to the friendship degree calculated, and the fourth generation means generates the meeting member candidate information by selecting other client apparatuses having a specific attribute based on an operation input through the operation input means.

Here, the attribute refers to a close friend, a friend, and an acquaintance, for example. With this structure, the user can purposefully narrow the meeting members, which can arrange the meeting members so as to meet the desire of the users.

In this case, the fourth generation means generates instruction information for instructing the server apparatus to adds, to the meeting member candidates, first another client apparatus having a specific attribute for second another client apparatus having a specific attribute based on the operation input through the operation input means, the second another client apparatus being selected by the fourth generation means, and the control means controls the communication means to transmit, to the server apparatus, the instruction information generated as the meeting member candidate information.

With this structure, the instruction information is transmitted to the server apparatus and the server apparatus is caused to select the meeting members in accordance with the instruction information, with the result that client apparatuses of, e.g., a close friend, a friend, or an acquaintance of a close friend, and a close friend, a friend, or an acquaintance of a friend, can be arranged as the meeting members. Thus, a person the user does not know can be arranged as the meeting member, so the user can further broaden relations among people.

In the client apparatus, the control means controls the communication means to transmit, to the server apparatus, information that indicates an intention of the first user of one of participation or nonparticipation in a meeting arranged based on the arranged meeting information received.

With this structure, it becomes possible to deliver an intention of participation/nonparticipation of the first user to the other members of the meeting arranged, and cause the server apparatus to perform processings such as rearrangement of the meeting arranged and cancellation.

According to another embodiment of the present invention, there is provided a server apparatus including: a communication means for receiving, from a plurality of client apparatuses, desired meeting information including desired meeting date/time information, desired meeting place information, and meeting member candidate information of a meeting, the desired meeting information being generated in the plurality of client apparatuses; a first generation means for generating, based on the desired meeting information received, a plurality of optimal client apparatus groups constituted of, as elements exclusive of each other, a plurality of client apparatuses having matched desired meeting information; a second generation means for determining an arranged date and time and an arranged meeting place for each of the plurality of optimal client apparatus groups, determining, as arranged meeting members, the plurality of client apparatuses belonging to the plurality of optimal client apparatus groups, and generating arranged meeting information indicating the arranged meeting date and time, the arranged meeting place, and the arranged meeting members; and a control means for controlling the communication means to transmit the arranged meeting information generated, to the plurality of client apparatuses as the arranged meeting members.

Here, the server apparatus refers to a PC or the like, but may be another electronic apparatus having a function as a server. The term “match” is used so as to contain a case where the meeting member candidates, the date/time range, and the place range are common among the client apparatuses, and a case where distances between the respective ranges are within the predetermined value even when those ranges do not have an overlap, in addition to the case where those members and ranges have an overlap.

With this structure, it is possible to automatically arrange the meeting and alleviate the burden of the user as the organizer, even when the meeting has high flexibility in the arrangement of the date and time, the place, and the members. Further, it is also possible to continue, deepen, and broaden the relations with the acquaintances, without tasks such as making direct contact with the acquaintances by a phone call or the like.

In the server apparatus the first generation means includes means for extracting, from client apparatuses included in the meeting member candidate information, client apparatuses having the desired meeting information and the desired meeting place information matched and a client apparatus having the meeting member candidate information generated, as a matching client apparatus group for each client apparatus, and means for generating, in a case where client apparatuses as elements of the matching client apparatus group extracted are regarded as a character string, an optimal client apparatus group set constituted of the optimal client apparatus groups having a minimum Levenshtein distance from a matching client apparatus group set constituted of all the matching client apparatus groups and having elements exclusive of each other.

With this structure, the Levenshtein distance is introduced, with the result that the desires of the client apparatuses are satisfied as much as possible and the plurality of meetings in which the members are not redundant can be arranged.

In the server apparatus, the control means controls the communication means to receives, from the plurality of client apparatuses, friendship information and instruction information, the friendship information indicating a friendship and a friendship degree between users of the plurality of client apparatuses, the instruction information indicating an instruction to add first another client apparatus with which second another client apparatus has a predetermined friendship degree to the meeting member candidates, the second another client apparatus having a predetermined friendship degree with each of client apparatuses generating the meeting member candidate information, and the first generation means adds the first another client apparatus to the meeting member candidate of each of client apparatuses based on the friendship information and the instruction information received.

With this structure, another client apparatus of a friend of a close friend, a close friend of a friend, a friend of a friend, or the like as the user can be added as the meeting member candidate. Therefore, even when a person the users of the client apparatuses do not know can be arranged as the meeting member, and thus relations with the acquaintances can be further broadened.

In the server apparatus, the first generation means encodes a predetermined client apparatus group set randomly selected from the plurality of client apparatuses to be a predetermined chromosome population, generates a chromosome population whose goodness of fit is maximum with the matching client apparatus groups by repeatedly performing a crossing-over processing, a mutation processing, and a growth and killing processing, and decodes the chromosome population, to thereby generate the optimal client apparatus group set.

With this structure, by using the genetic algorism, the optimal client apparatus group set that is as approximate to the optimal value as possible can be generated.

In the server apparatus, the desired meeting date/time information includes information on a desired meeting date, a desired meeting starting time, and a desired meeting ending time, and the second generation means calculates an average time of desired meeting starting times of client apparatuses belonging to the optimal client apparatus groups as an arranged meeting starting time, and calculates an average time of desired meeting ending times of the client apparatuses as an arranged meeting ending time.

With this structure, a time as close to the desired meeting starting times and a time as close to the desired meeting ending times of the client apparatuses belonging to the optimal client apparatus groups as possible can be arranged as the arranged meeting starting time and the arranged meeting ending time, respectively. There may occur a case where the desired meeting time period of the client apparatuses belonging to the optimal client apparatus groups have no overlap. Even in this case, by calculating the average time, the desires of the client apparatuses can be satisfied as much as possible.

In the server apparatus, the desired meeting place information includes tolerable movement distance range information indicating a distance range capable of being tolerated by users from movement original positions of the users of the plurality of client apparatuses, and the second generation means determines, to be the arranged meeting place, a place within a predetermined distance range around a weighted center of a sum of sets of the tolerable movement distance ranges of the plurality of clients belonging to the optimal client apparatus groups.

With this structure, a place as close to the places of the client apparatuses belonging to the optimal client apparatus groups as possible can be arranged as the arranged meeting place. There may occur a case where the desired meeting place ranges of the client apparatuses belonging to the optimal client apparatus groups have no overlap. Even in this case, by calculating the weighted center of the sum of the sets of the tolerable movement distance ranges, the desires of the client apparatuses can be satisfied as much as possible.

In this case, the control means controls the communication means to receive map information including information on a facility located within the predetermined distance range around the weighted center of the sum of the sets of the tolerable movement distance ranges, and the second generation means determines the facility to be the arranged meeting place based on the map information received.

With this structure, the meeting arrangement place can be arranged as a place where the members get together in an easy-to-understand way by the users of the client apparatuses as the arranged meeting members.

According to another embodiment of the present invention, there is provided a meeting arrangement system including a server apparatus and a plurality of client apparatuses. In the meeting arrangement system, each of the plurality of client apparatuses includes a first communication means for communicating with a server apparatus and another client apparatus, a first generation means for generating, based on communication history information with the plurality of other client apparatuses by the communication means, friendship information indicating a friendship between a first user of the client apparatus and each of second users of the plurality of other client apparatuses, a storage means for storing schedule information including scheduled date/time information and scheduled place information of a scheduled event for the first user and meeting history information including date/time history information, place history information, and member history information of a meeting arranged in a past, a second generation means for generating desired meeting date/time information of the first user based on the scheduled date/time information and the date/time history information stored, a third generation means for generating desired meeting place information of the first user based on the scheduled place information stored, the place history information stored, and desired meeting date/time information generated, a fourth generation means for generating meeting member candidate information indicating candidates of client apparatuses to be meeting members based on the friendship information generated, and a first control means for controlling the first communication means to transmit, to the server apparatus, the desired meeting date/time information, the desired meeting place information, and the meeting member candidate information generated as desired meeting information, and controlling the first communication means to receive arranged meeting information arranged by the server apparatus based on the desired meeting information transmitted. The server apparatus includes a second communication means for receiving desired meeting information transmitted from the plurality of client apparatuses, a fifth generation means for generating, based on the desired meeting information received, a plurality of optimal client apparatus groups constituted of, as elements exclusive of each other, a plurality of client apparatuses having matched desired meeting information, a sixth generation means for determining an arranged date and time and an arranged meeting place for each of the plurality of optimal client apparatus groups, determining, as arranged meeting members, the plurality of client apparatuses belonging to the plurality of optimal client apparatus groups, and generating arranged meeting information indicating the arranged meeting date and time, the arranged meeting place, and the arranged meeting members, and a second control means for controlling the communication means to transmit the arranged meeting information generated, to the plurality of client apparatuses as the arranged meeting members.

According to another embodiment of the present invention, there is provided a meeting arrangement method using a server apparatus and a plurality of client apparatuses. The meeting arrangement method includes: generating, based on communication history information with the plurality of other client apparatuses, friendship information indicating a friendship between a first user of the client apparatus and each of second users of the plurality of other client apparatuses; storing schedule information including scheduled date/time information and scheduled place information of a scheduled event for the first user and meeting history information including date/time history information, place history information, and member history information of a meeting arranged in a past; generating desired meeting date/time information of the first user based on the scheduled date/time information and the date/time history information stored; generating desired meeting place information of the first user based on the scheduled place information stored, the place history information stored, and desired meeting date/time information generated; generating meeting member candidate information indicating candidates of client apparatuses to be meeting members based on the friendship information generated; transmitting, to the server apparatus, the desired meeting date/time information, the desired meeting place information, and the meeting member candidate information generated as desired meeting information; receiving the desired meeting information transmitted from the plurality of client apparatuses; generating, based on the desired meeting information received, a plurality of optimal client apparatus groups constituted of, as elements exclusive of each other, a plurality of client apparatuses having matched desired meeting information; determining an arranged date and time and an arranged meeting place for each of the plurality of optimal client apparatus groups, determining, as arranged meeting members, the plurality of client apparatuses belonging to the plurality of optimal client apparatus groups, and generating arranged meeting information indicating the arranged meeting date and time, the arranged meeting place, and the arranged meeting members; and transmitting the arranged meeting information generated, to the plurality of client apparatuses as the arranged meeting members. The former six steps stated above are executed by the plurality of client apparatuses, and the latter four steps stated above are executed by the server apparatus.

According to another embodiment of the present invention, there is provided a client apparatus, including: a communication unit capable of communicating with a server apparatus and a plurality of other client apparatuses; a first generator to generate, based on communication history information with the plurality of other client apparatuses by the communication unit, friendship information indicating a friendship between a first user of the client apparatus and each of second users of the plurality of other client apparatuses; a storage unit to store schedule information including scheduled date/time information and scheduled place information of a scheduled event for the first user and meeting history information including date/time history information, place history Information, and member history information of a meeting arranged in a past; a second generator to generate desired meeting date/time information of the first user based on the scheduled date/time information and the date/time history information stored; a third generator to generate desired meeting place information of the first user based on the scheduled place information stored, the place history information stored, and desired meeting date/time information generated; a fourth generator to generate meeting member candidate information indicating candidates of client apparatuses to be meeting members based on the friendship information generated; and a controller to control the communication unit to transmit, to the server apparatus, the desired meeting date/time information, the desired meeting place information, and the meeting member candidate information generated as desired meeting information, and control the communication unit to receive arranged meeting information arranged by the server apparatus based on the desired meeting information transmitted.

According to another embodiment of the present invention, there is provided a server apparatus, including: a communication unit to receive, from a plurality of client apparatuses, desired meeting information including desired meeting date/time information, desired meeting place information, and meeting member candidate information of a meeting, the desired meeting information being generated in the plurality of client apparatuses; a first generator to generate, based on the desired meeting information received, a plurality of optimal client apparatus groups constituted of, as elements exclusive of each other, a plurality of client apparatuses having matched desired meeting information; a second generator to determine an arranged date and time and an arranged meeting place for each of the plurality of optimal client apparatus groups, determine, as arranged meeting members, the plurality of client apparatuses belonging to the plurality of optimal client apparatus groups, and generate arranged meeting information indicating the arranged meeting date and time, the arranged meeting place, and the arranged meeting members; and a controller to control the communication unit to transmit the arranged meeting information generated, to the plurality of client apparatuses as the arranged meeting members.

As described above, according to the embodiments of the present invention, the burden imposed on the organizer who arranges the private meeting having high arrangement flexibility can be alleviated, and the private exchange among people can be encouraged.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a diagram showing a structure of a meeting arrangement system according to an embodiment of the present invention;

FIG. 2 is a block diagram showing a hardware structure of each of clients according to the embodiment of the present invention;

FIG. 3 is a block diagram showing a hardware structure of a server according to the embodiment of the present invention;

FIG. 4 is a diagram showing a structure of functional blocks of the client according to the embodiment of the present invention;

FIG. 5 is a diagram showing a structure of functional blocks of the server according to the embodiment of the present invention;

FIG. 6 is a flowchart showing an entire operation flow of the meeting arrangement system according to the embodiment of the present invention;

FIG. 7 are diagrams each showing model rules 1 and 2 and histories 1 and 2 regarding a date, each of which is represented using a fuzzy set according to the embodiment of the present invention;

FIG. 8 are diagrams showing an equivalence operation process of fuzzy sets of a model rule and a meeting participation history regarding a date according to the embodiment of the present invention;

FIG. 9 are diagrams showing an equivalence operation process of fuzzy sets of a model rule and a meeting participation history regarding a date according to the embodiment of the present invention;

FIG. 10 are diagrams showing an equivalence operation process of fuzzy sets of a model rule and a meeting participation history regarding a date according to the embodiment of the present invention;

FIG. 11 are diagrams showing an equivalence operation process of fuzzy sets of a model rule and a meeting participation history regarding a date according to the embodiment of the present invention;

FIG. 12 are diagrams showing equivalent operation results between the model rules, and the histories according to the embodiment of the present invention;

FIG. 13 is a flowchart showing a process flow of determining an availability estimation rule according to the embodiment of the present invention;

FIG. 14 is a flowchart showing a process flow of estimating an availability using the availability estimation rule determined, according to the embodiment of the present invention;

FIG. 15 are diagrams showing fuzzy set representations of model rules regarding a time according to the embodiment of the present invention;

FIG. 16A is a diagram showing a histogram representation in a case where a past history of meeting participation times shows most frequency in a period of 8 to 10 p.m., and FIG. 16B is a diagram showing a fuzzy set generated therefrom, according to the embodiment of the present invention;

FIG. 17 is a diagram showing a fuzzy set representation of a model rule regarding a date and a time, according to the embodiment of the present invention;

FIG. 18 is a flowchart showing a process flow of estimating a desired meeting place range according to the embodiment of the present invention.

FIG. 19 are diagrams showing examples of a tolerance function and a desired meeting place range using the tolerance function according to the embodiment of the present invention;

FIG. 20 are diagrams showing examples of a tolerance function and a desired meeting place range using the tolerance function according to the embodiment of the present invention;

FIG. 21 is a flowchart showing a process flow of generating a matching client group according to the embodiment of the present invention;

FIG. 22 is a conceptual diagram showing a matching processing of a desired meeting place range according to the embodiment of the present invention;

FIG. 23 is a diagram showing a method of calculating a Levenshtein distance between an arbitrary client group set and a matching client group according to the embodiment of the present invention;

FIG. 24 is a diagram showing a method of calculating a Levenshtein distance between matching client groups of all the clients and an arbitrary client group set according to the embodiment of the present invention;.

FIG. 25 is a diagram showing a graph representation of distances between arbitrary sets S1 and S2 and a set M of the matching client groups of all the clients in the embodiment of the present invention;

FIG. 26 is a flowchart showing a process flow of generating an optimal meeting client group set according to the embodiment of the present invention;

FIG. 27 is a diagram showing an example of an initial chromosome population generated according to the embodiment of the present invention;

FIG. 28 is a conceptual diagram showing a crossing-over operation of genetic algorisms according to the embodiment of the present invention;

FIG. 29 is a conceptual diagram showing a mutation processing of the genetic algorisms according to the embodiment of the present invention;

FIG. 30 is a conceptual diagram showing a reproduction processing of the genetic algorisms according to the embodiment of the present invention;

FIG. 31 are conceptual diagrams showing a case where the optimal meeting client group includes a client pair with no overlap regarding a meeting time period and a meeting place in the embodiment of the present invention; and

FIG. 32 are conceptual diagrams showing a case where the optimal meeting client group includes a client pair with no overlap regarding the meeting place in the embodiment of the present invention.

### DESCRIPTION OF PREFERRED EMBODIMENT

Hereinafter, embodiments of the present invention will be described with reference to the drawings.

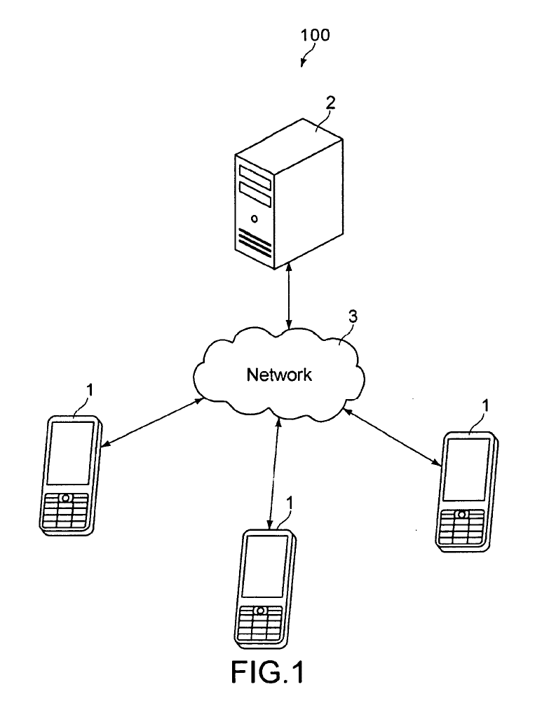

FIG. 1 is a diagram showing a structure of a meeting arrangement system according to an embodiment of the present invention.

As shown in FIG. 1, a meeting arrangement system 100 is constituted of a plurality of clients 1 and a server 2. The plurality of clients 1 and the server 2 are connected to a network 3 such as the Internet and a LAN (Local Area Network), and can be communicated with each other.

Each of the plurality of clients 1 is, for example, a portable electronic apparatus such as a mobile phone, a PDA, a smart phone, and a laptop PC, but may be a stationary electronic apparatus such as a desktop PC. The server 2 is a stationary PC or the like, but may be another electronic apparatus.

In the meeting arrangement system 100, the plurality of clients 1 each create desired meeting information regarding a private meeting and send the information to the server 2. The server 2 coordinates the desired meeting information of the clients 1 to automatically arrange a plurality of meetings that do not interfere with each other.

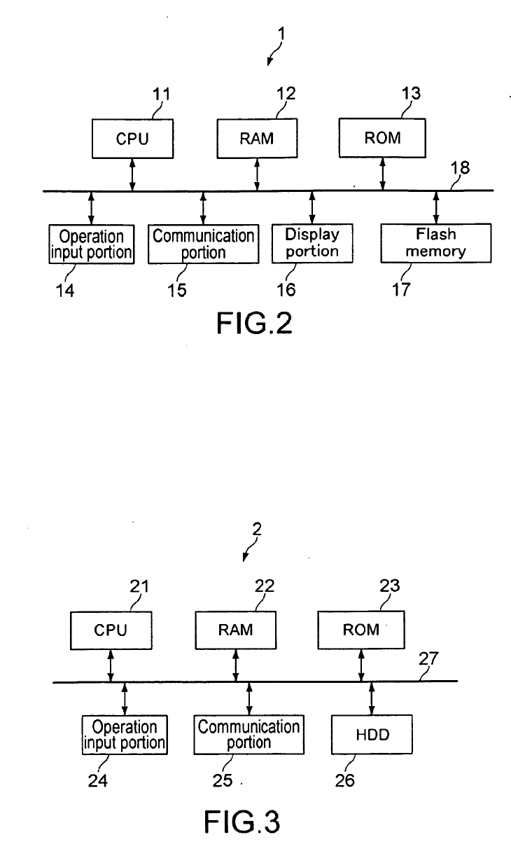

FIG. 2 is a block diagram showing a hardware structure of each of the clients 1.

As shown in FIG. 2, the client 1 includes a CPU (Central Processing Unit) 11, a RAM (Random Access Memory) 12, a ROM (Read Only Memory) 13, an operation input unit 14, a communication unit 15, a display unit 16, a flash memory 17, and the like, which are connected via a bus 18.

The CPU 11 properly accesses the RAM 12 and the like as necessary, and performs overall control on blocks of the client 1 while performing various computation processings. The RAM 12 is used as a work area or the like for the CPU 11, and temporarily stores an OS, various active programs, and various data in processing. The ROM 13 is a non-volatile memory in which an OS, a program, and firmware such as various parameters which are executed by the CPU 11 are fixedly stored.

The operation input unit 14 is structured by, e.g., a button, a switch, a keyboard, a mouse, or a touch panel. With the operation input unit 14, various instructions are input by an operation of a user of each client 1, and output to the CPU 11.

The communication unit 15 is constituted of an antenna for transmitting/receiving an electric wave of a predetermined frequency, a wavelength conversion unit, a modem unit, and the like. The communication unit 15 serves as an interface through which the client 1 performs data communication with another client 1 or the server 2, or talks with another client 1 by a W-CDMA system or a CDMA 2000 system, for example.

The display unit 16 is formed of a TFT (Thin Film Transistor) or the like, and serves as a liquid crystal display having a VGA (Video Graphics Array) size, for example. The display unit 16 may function as a touch panel.

The flash memory 17 is, e.g., a NAND type, and stores various programs and various data such as friendship model data and meeting history data described later.

FIG. 3 is a block diagram showing a hardware structure of the server 2.

As shown in FIG. 3, the server 2 includes a CPU 21, a RAM 22, a ROM 23, an operation input unit 24, a communication unit 25, an HDD (Hard Disk Drive) 26, and the like, which are connected via a bus 27. The CPU 21, the RAM 22, the ROM 23, and the operation input unit 24 have the same functions as the CPU 11, the RAM 12, the ROM 13, and the operation input unit 14 of the client 1, respectively, so their descriptions will be omitted.

The communication unit 25 serves as an interface through which the clients 1 are communicated with each other via the network 3 by the FTTX or ADSL, for example.

The HDD 26 stores the OS, the various programs, and the various data such as the desired meeting information data and the friendship model data (described later) of the clients 1 into a built-in hard disk, and reads them from the hard disk to the RAM 22.

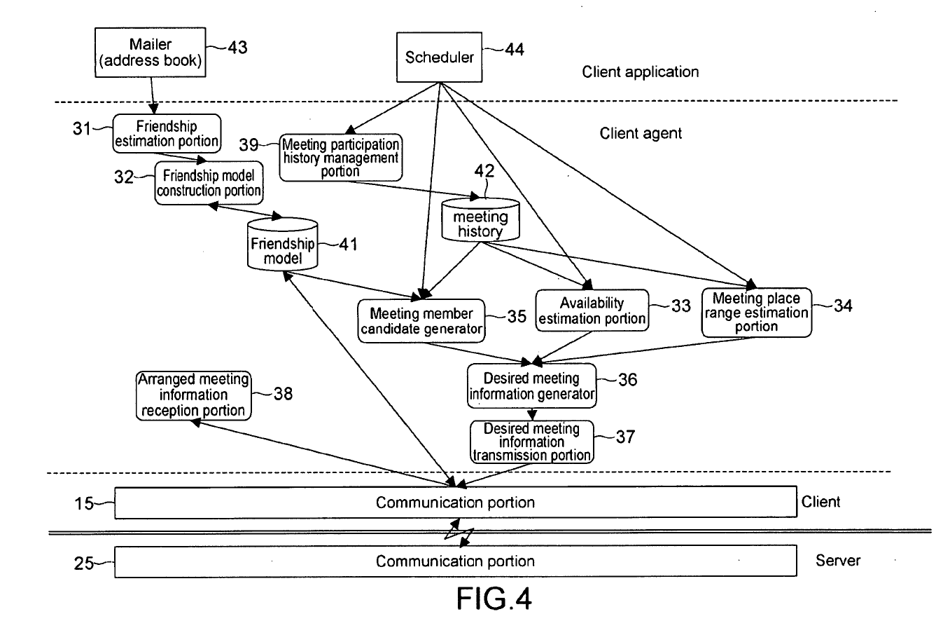

FIG. 4 is a diagram showing a structure of functional blocks of the client 1.

As shown in FIG. 4, each of the client 1 includes functional blocks such as a friendship estimation unit 31, a friendship model construction unit 32, an availability estimation unit 33, a meeting place range estimation unit 34, a meeting member candidate generator 35, a desired meeting information generator 36, a desired meeting information transmission un-t 37, a arranged meeting information reception unit 38, and a meeting participation history management unit 39. Those constituents have a form of a program that cooperates with the CPU 11 (hereinafter, referred to as an agent).

An agent of each of the clients 1 includes a friendship model database 41: and a meeting history database 42, as databases. Further, the clients 1 each include, as applications, a mailer 43 having an address database (hereinafter, referred to as an address book) and an e-mail communication history, and a schedule management tool (hereinafter, referred to as a scheduler) 44 for managing schedule information of users of the clients 1. In the address book of the mailer 43, data such as names, phone numbers, and e-mail addresses of other clients is stored. In the communication history of the mailer 43, a transmission source, a transmission destination, a transmission date and time, a reception date and time, a message, and the like of e-mail transmitted/received between the clients 1 are stored. In the scheduler 44, schedule information such as a date and a time, and a place of a planned event for each of the users of the clients 1, and positional information of users' homes and offices are stored.

The friendship estimation unit 31 estimates degrees of a friendship between each user of the clients 1 and the other users thereof based on the address book and transmission/reception history data of the e-mail and phone call stored by the mailer 43.

The friendship model construction unit 32 constructs, as a friendship model database 41, a model that indicates the degrees of the friendship of the user of the client 1 with the other respective users thereof based on the degrees of the friendship estimated by the friendship estimation unit 31, and updates the friendship model database 41.

Specifically, the friendship model database 41 stores, as basic attribute Information, information such as names, e-mail addresses, and addresses of the other users of the clients 1 with whom each user of the clients 1 has the friendship. The friendship model database 41 also stores, as friendship attribute information, label information (such as a “close friend”, a “friend”, and an “acquaintance”) that indicates the degrees of the friendship between each user of the clients 1 and the other users thereof. The friendship model information is transmitted to the server 2 as appropriate, and is managed by the server 2 collectively with friendship model information of the other clients. It should be noted that the friendship model database 41 may be constructed by a direct input from the user through the operation input unit 14.

The availability estimation unit 33 estimates availability of the users of the clients 1 with respect to an automatic meeting arrangement on a date and a time in the future (i.e., a degree by which the meeting is allowed to be arranged on a certain date and time in the future for the users of the clients 1) based on the users' schedule information obtained from the scheduler 44 and the meeting history information stored in the meeting history database 42, and outputs the availability as desired meeting date/time information. In this embodiment, the output availability is indicated as a binary representation of “available (drinking party arrangement OK)” or “unavailable (drinking party arrangement NG)”.

The meeting arrangement system 100 automatically arranges a meeting on a date and a time that is “available” as a result estimated by the availability estimation unit 33. To put it simply, the meeting arrangement system 100 estimates, based on the users' habits (participation histories in the meetings in the past), a date and a time in the future on which the users of the clients 1 “feel that the drinking party has not been held for a while and feel like joining the drinking party again”, and automatically recommends a drinking party arrangement.

The meeting place range estimation unit 34 estimates a meeting place range where the users of the clients 1 can gather on the date and time (desired meeting date and time) in the future that is estimated as “available” by the availability estimation potion 33, and outputs the estimated place range as desired meeting place range information.

The meeting member candidate generator 35 generates candidates of members of the meeting that is desired to be held on the above-mentioned desired meeting date and time and desired meeting place, with reference to information and the like on the past meeting members stored in the meeting history database 42.

The desired meeting information generator 36 collectively processes the desired meeting date and time, the desired meeting place range, and the meeting member candidates generated by the availability estimation unit 33, and the meeting place range estimation unit 34, and the meeting member candidate generator 35, respectively, into a data structure (hereinafter, referred to as desired meeting information), and outputs the desired meeting information to the desired meeting information transmission unit 37.

The desired meeting information transmission unit 37 timely transmits the desired meeting information output from the desired information generator 36 to the server 2.

It should be noted that the desired meeting information may be directly input by the user with the operation input unit 14 of the client 1. That is, when the user directly inputs the desired meeting date and time, the desired meeting place range, and the meeting member candidate, the input desired meeting information is preferentially transmitted to the server 2.

The arranged meeting information reception unit 38 receives information on the meeting automatically arranged by the server 2 (hereinafter, referred to as arranged meeting information). The arranged meeting information is stored in a state of being available for browse by the scheduler 44. The users of the clients 1 browse and confirm the arranged meeting information through the scheduler 44 and the display unit 16. The arranged meeting information may be received by the mailer 43 as e-mails and stored therein.

In a case where the user has actually participated in the meeting automatically arranged by the server 2, the meeting participation history management unit 39 obtains meeting information (meeting date and time, meeting place positional information, most-recently scheduled place positional information (positional information of an original meeting place), a moving distance from the original meeting place to the meeting place where the meeting is held, and meeting members) with reference to the information in the scheduler 44 as appropriate, and stores the meeting information in the meeting history database 42.

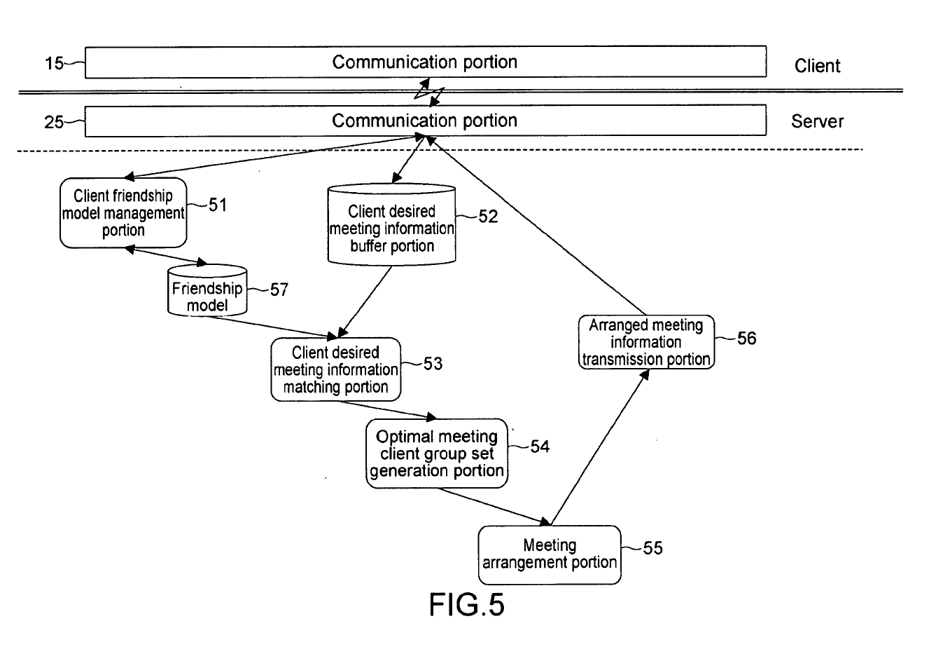

FIG. 5 is a diagram showing a structure of functional blocks of the server 2.

As shown in FIG. 5, the server 2 includes functional blocks such as a client friendship model management unit 51, a client desired meeting information buffer unit 52, a client desired meeting information matching unit 53, an optimal meeting client group set generation unit 54, a meeting arrangement unit 55, and an arranged meeting information transmission unit 56. The functional blocks have a form of a program that cooperates with the CPU 21. In addition, the server 2 stores friendship models received from the clients 1 as a friendship model database 57.

The client friendship model management unit 51 manages, with a file system, the friendship models of the users of the clients 1 timely transmitted from the friendship model construction unit 32 of each of the clients 1. For an inquiry with respect to the client friendship model management unit 51, a client ID of a reference-target client 1 is used, and an output in response to the inquiry functions as a friendship model of the client 1.

The client desired meeting information buffer unit 52 temporarily buffers the desired meeting information of the clients 1 timely transmitted from the desired meeting information transmission unit 37 of each of the clients 1.

The client desired meeting information matching unit 53 extracts, based on the desired meeting information buffered in the client desired meeting information buffer unit 52, a client group constituted of clients whose desired date and time and desired meeting place range match (hereinafter, referred to as a matching client group) from among the clients 1 as the meeting member candidates in the desired meeting information.

The optimal meeting client group set generation unit 54 generates, based on the matching client group of the whole clients 1 extracted by the client desired meeting information matching unit 53, an optimal meeting client group set such that the clients 1 are not contained redundantly and as many requests of the clients 1 (desired meeting information) as possible are met.

The meeting arrangement unit 55 further coordinates desired meeting information items of a plurality of clients 1 that belong to optimal meeting client groups as elements of the optimal meeting client group set generated by the optimal meeting client group set generation unit 54, to thereby finally arrange the meeting.

The arranged meeting information transmission unit 56 transmits, as arranged meeting information, information on a meeting date and time and a meeting place that are finally decided to the whole clients 1 belonging to the optimal meeting client group.

Subsequently, an operation of the meeting arrangement system 100 structured as described above will be described.

First, processings of the client 1 will be described.

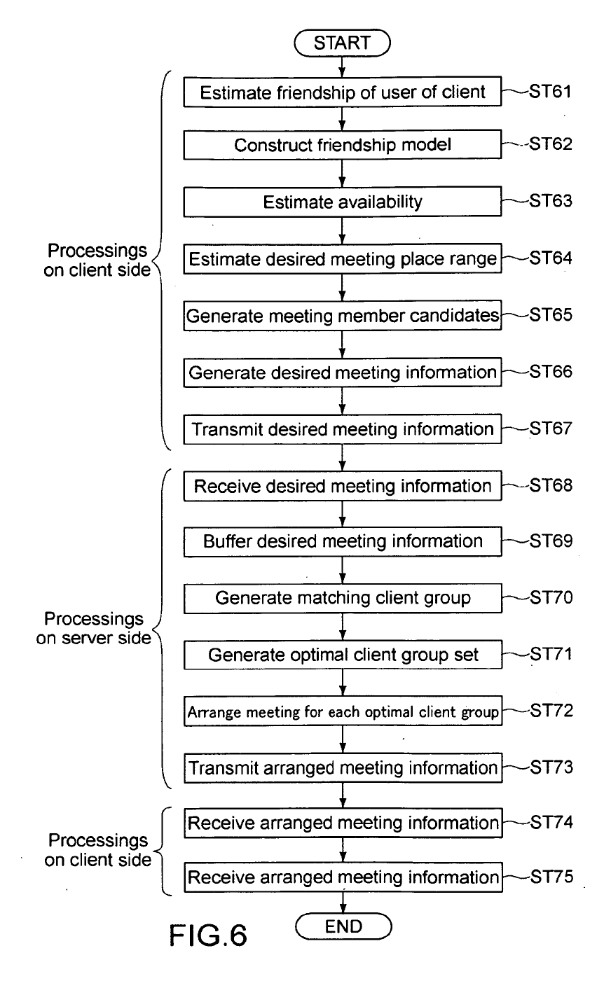

FIG. 6 is a flowchart showing an entire operation flow of the meeting arrangement system 100 in this embodiment.

As shown in FIG. 6, the CPU 11 of each of the clients 1 estimates friendships between the users of the clients 1 by the friendship estimation unit 31 (Step 61). Hereinafter, a friendship estimation processing will be described in detail.

A person to be subjected to the friendship estimation with the users of the clients 1 has at least basic information (name and e-mail address) registered in the address book. The friendship estimation unit 31 defines a friendship degree function in which a friendship degree is proportional to a transmission/reception frequency obtained from the transmission/reception history of the e-mails and phone calls with respect to a person Pi as an estimation target.

First, the friendship estimation unit 31 defines a friendship frequency FQ(Pi) with respect to the person Pi by the following friendship frequency function.

FQ(Pi)=α*FQoff(Pi)+(1−α)*FQon(Pi) (1)

In the expression (1), FQoff(Pi) represents a total count of the transmissions/receptions of the e-mails and phone calls during off-duty hours in a set period (e.g., in the past week, the past month, the past half year, the past year). FQon(Pi) represents a total count of the transmissions/receptions of the e-mails and phone calls during on-duty hours in the set period. α is a weighting factor set within a range of 0≦α≦1. The on-duty hours are set as 8 a.m. to 6 p.m. on Monday to Friday and the off-duty hours are set as 6 p.m. to midnight, for example, but are not limited thereto.

In general, communications with friends or acquaintances are often performed during the off-duty hours. Therefore, α in the friendship frequency function is desirably set to be larger than 0.5, more desirably, 0.7 to 0.8. This setting can provide an estimation function in which a person with whom off-duty communication is more frequent is set to have a higher friendship degree. It should be noted that α may be set to 1.0. In other words, the friendship estimation unit 31 may ignore the total count of on-duty transmissions/receptions.

The friendship estimation unit 31 defines a friendship degree FR(Pi) by a probability of a friendship frequency. That is, the friendship degree FR is defined by a ratio of the friendship frequency of the target person to the sum of the friendship frequencies of the whole persons registered in the address book as follows.

FR(Pi)=FO(Pi)/ΣiFO(Pi) (2)

Upon request of the friendship estimation with respect to the person Pi from the CPU 11, the friendship estimation unit 31 calculates FR(Pi) based on the above expressions (1) and (2), and outputs a calculation result.

Next, the CPU 11 constructs the friendship models of the users of the clients 1 by the friendship model construction unit 32 (Step 62). Hereinafter, processings of the friendship model construction will be described in detail.

As described above, the friendship model is constituted of the basic attribute information that indicates a name, an e-mail address, and a address and the friendship attribute information that indicates labels (close friend, friend, acquaintance, and the like) showing the friendship degrees.

The friendship model construction unit 32 first refers to the address book, and obtains the basic information of the target person Pi. Then, the friendship model construction unit 32 gives a label of “close friend, friend, acquaintance” (in descending order of FR values) or the like based on the FR(Pi) in accordance with a predetermined rule, to generate the friendship attribute information. The friendship model construction unit 32 transmits the constructed friendship model to the server 2 as appropriate. The transmitted friendship model is collectively managed with friendship models of the other clients 1. Therefore, for updating the constructed friendship model, the friendship model construction unit 32 downloads the friendship model of its own from the server 2 before update, updates the friendship model, and uploads it to the server 2.

The label indicating the friendship degree of the friendship attribute information may be directly input by the user through the operation input unit 14. In this case, the friendship degree label is input when the target person Pi is registered into the address book and when the information registered in the address book is changed, for example.

Subsequently, the CPU 11 estimates the availabilities of the users of the clients 1, that is, desired meeting dates and times (Step 63). Hereinafter, availability estimation processings will be described in detail.

In this embodiment, the availability estimation unit 33 performs estimation according to a rule that matches most with the history regarding dates and times on which the users of the clients 1 have participated in the past meetings.

The availability estimation unit 33 stores in advance, into the flash memory 17 or the like, a plurality of model rules regarding dates (e.g., “every day”, “every day (except Saturday and Sunday)”, “every weekend”, “every x (day of the week)”, “the x-th of each month”, “the x-th week of each month”, and “at the beginning, in the middle, or at the end of each month”) and a plurality of model rules regarding times (e.g., “after x o'clock”, “before x o'clock”, or “x to x o'clock”) as a model rule group to be subjected to the availability estimation.

The availability estimation unit 33 sets, to an availability estimation rule, a model rule that matches most (has a high matching degree) with the history data of the meetings that the users have joined in the past, the history data being stored in the meeting history database 42. Further, the availability estimation unit 33 obtains the schedule information of the users from the scheduler 44 of each of the clients 1, and modifies the estimation result so that a date and a time when the user already has another plan out of “available” dates and times obtained according to the availability estimation rule, are changed into “unavailable”, to thereby provide a final estimation result.

Here, a description will be given on a case where a fuzzy logic operation is used as a method of comparing the model rule and the meeting participation history (matching degree calculation method). The fuzzy logic is employed because it is convenient to use a fuzzy set when a representation by a natural language (e.g., “every weekend” and “after x o'clock”) ranges in number to some extent is converted into an arithmetic representation.

As an example, a description will be given on a method of calculating the matching degree between model rules 1 and 2 and histories 1 and 2 by using the fuzzy logic. The model rule 1 is “available every weekend” and the model rule 2 is “available every Wednesday”. The history 1 is “a case of participating in at least one of Saturday and Sunday meetings almost every week in the past 8 weeks” and the history 2 is “a case of participating in Wednesday meetings almost every week”.

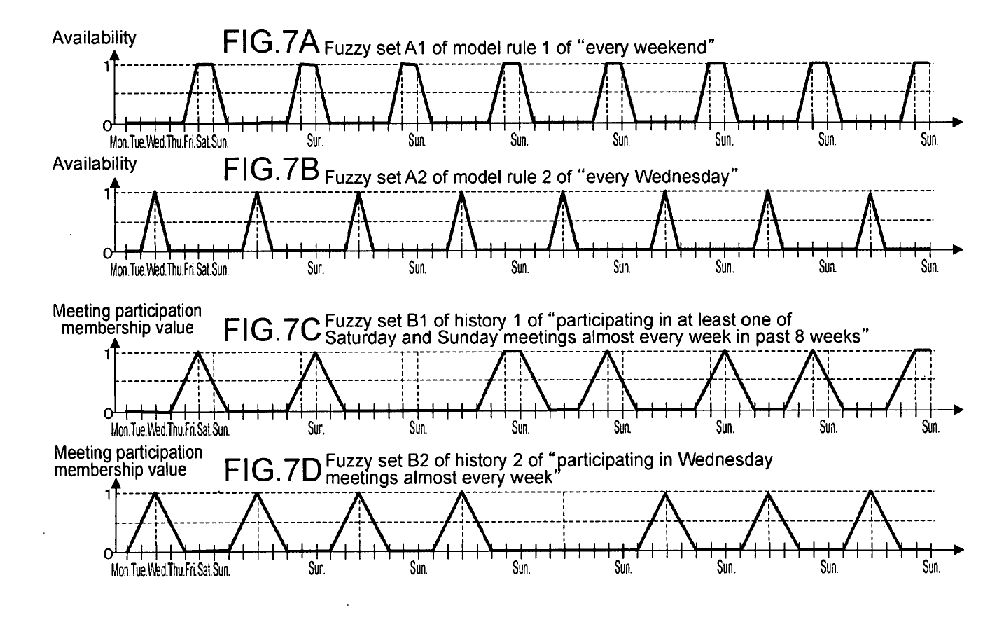

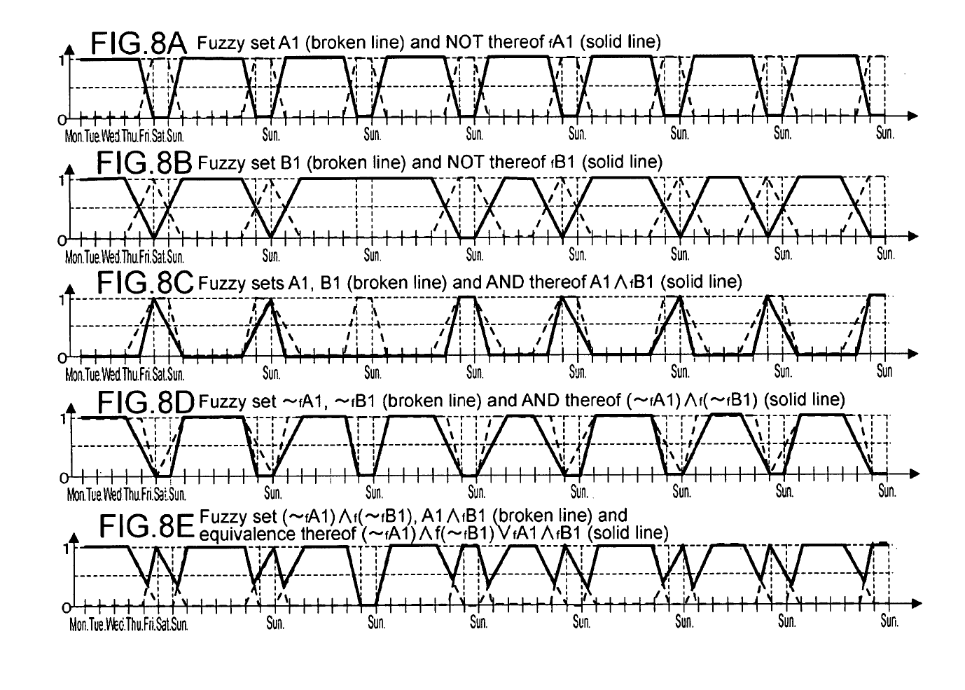

FIGS. 7A to 7D are diagrams respectively showing the model rules 1 and 2 and the histories 1 and 2, each of which is represented using a fuzzy set.

FIG. 7A shows a representation of the model rule 1 of “available every weekend” using the fuzzy set. An abscissa axis is a discrete-time axis in a calendar manner and is scaled for each day. A longitudinal axis represents degrees of the availability (expressed by real values ranging from 0 to 1 before binarization). Generally, values on the longitudinal axis of the fuzzy set are called membership values, and are outputs from a membership function with variables being set on the abscissa axis. The representation of “available every weekend” is defined by a triangular membership function whose height is 1 on the abscissa corresponding to each Saturday and Sunday. It should be noted that in this example, because the abscissa is discrete, the fuzzy set is equivalent to a crisp set, but there is not particular problem for generalization. Meanwhile, FIG. 7B is a representation of the model rule 2 of “available every Wednesday” using the fuzzy set.

Further, for a fuzzy set representation of the meeting participation history, a triangular membership function having a membership value of 1 for a day when the user has participated in the meeting and 0.5 for each of the preceding and following days is used, for example. FIG. 7C shows a representation of the fuzzy set of the history 1, i.e., “a case of participating in at least one of Saturday and Sunday meetings almost every week in the past 8 weeks”. FIG. 7D shows a representation of the fuzzy set of the history 2, i.e., “a case of participating in the Wednesday meeting almost every week”.

Subsequently, a calculation process of the matching degree of the model rules and the meeting participation histories will be described in detail. First, the fuzzy sets of the model rules and the meeting participation histories are subjected to an equivalence (exclusive NOR) operation. For example, in the crisp (not fuzzy) logic, the equivalence between A and B, “A [symbol] B”, is expressed as “˜AA [symbol] ˜B [symbol] A [symbol] B”, where [symbol] represents OR, [symbol] represents AND, and ˜ represents NOT. Membership functions of fuzzy sets A and B are represented by μ_{A}(x) and μ_{B}(x), respectively. The membership functions are each considered to be a multiple-valued (real value having [0, 1])) function of truth values with respect to propositions represented by the fuzzy sets, with the result that the model rules and the meeting participation histories can be grasped in a fuzzy logical system. The logical operations above are expanded in the fuzzy logic as follows.

[Fuzzy OR [symbol] _{f}]

A [symbol] _{f}B=max(μ_{A}(x), μ_{B}(x)) (1)

(Fuzzy AND [symbol] _{f})

A [symbol] _{f}B=min(μ_{A}(x), μ_{B}(x)) (2)

[Fuzzy NOT (fuzzy complementary set) ˜_{f}]

˜_{f}A=1−μ_{A}(x) (3)

The equivalence A [symbol] _{f}B of the fuzzy sets A and B is to be obtained here. This can be obtained by calculating the following expression.

A [symbol] _{f}B=(˜_{f}A) [symbol] _{f}(˜_{f}B) [symbol] _{f}A [symbol] _{f}B (4)

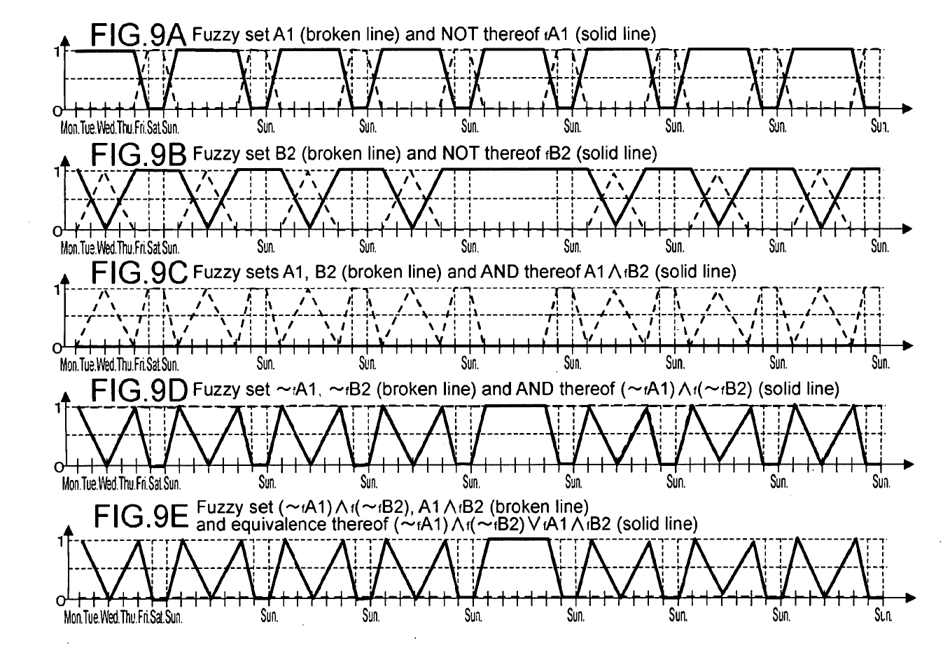

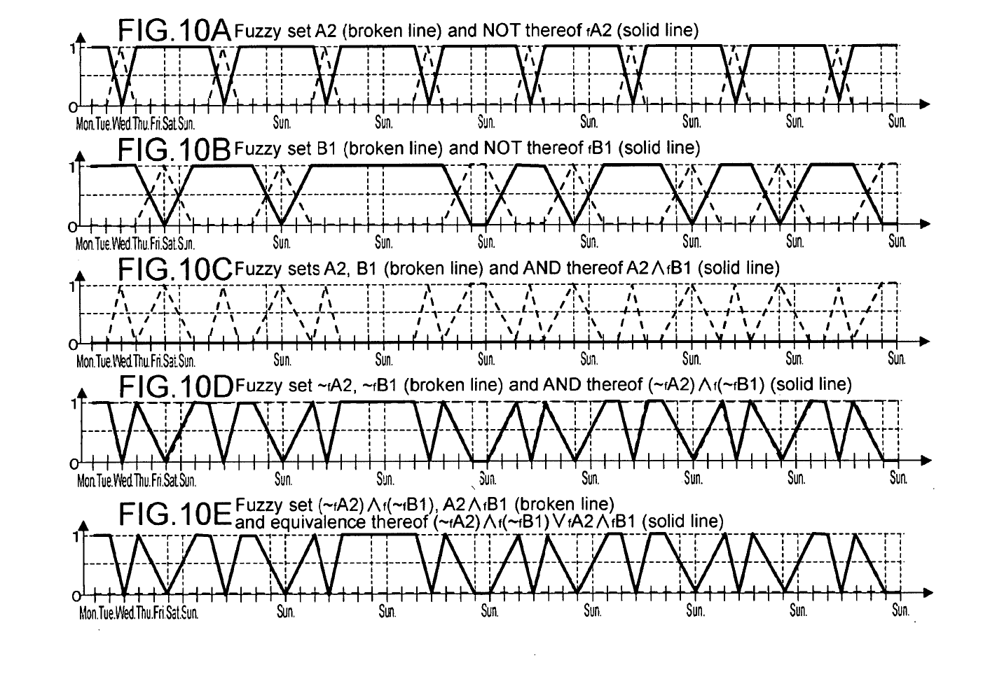

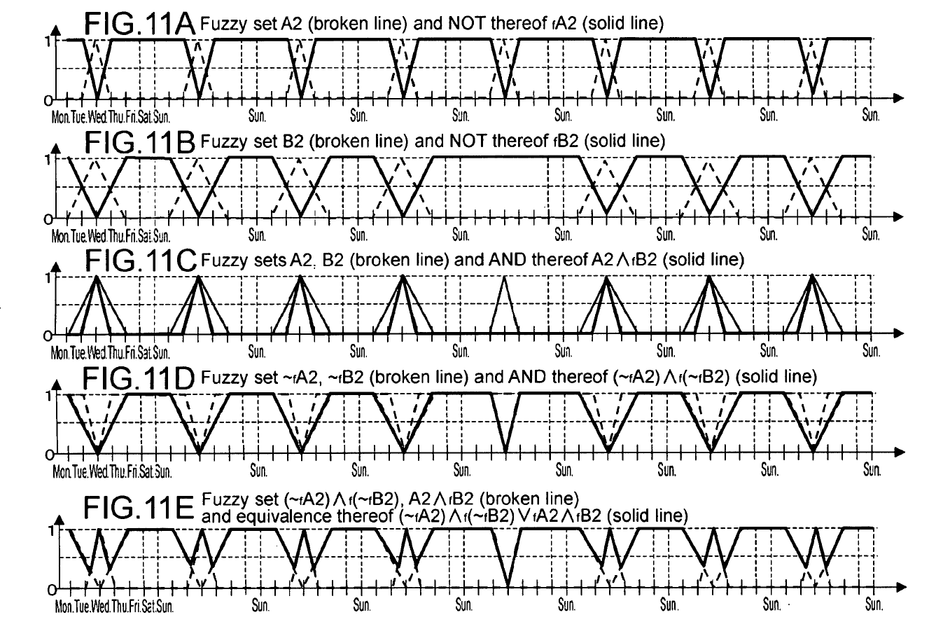

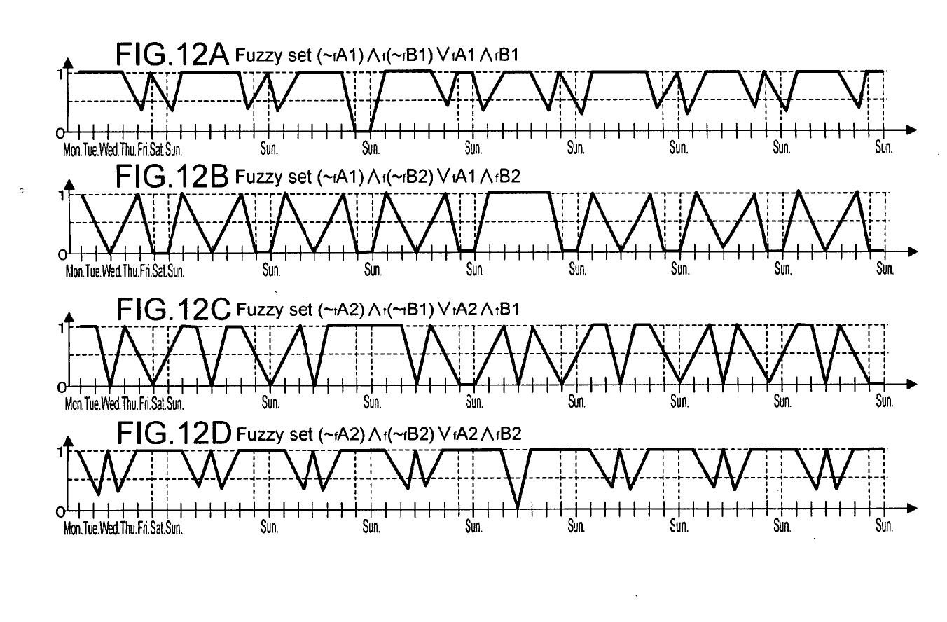

FIGS. 8 to 11 are diagrams showing processes of the above logical operations. In those figures, the model rules 1 and 2 and the histories 1 and 2 are expressed as the fuzzy sets A1, A2, B1, and B2, respectively. FIG. 8 each show an equivalence operation process of the fuzzy sets A1 and B1. FIG. 9 each show an equivalence operation process of the fuzzy sets A1 and B2. FIG. 10 each show an equivalence operation process of the fuzzy sets A2 and B1. FIG. 11 each show an equivalence operation process of the fuzzy sets A2 and B2.

FIG. 12 are diagrams showing respective equivalent operation results between the model rule 1 of “available every week” and the model rule 2 of “available every Wednesday”, and the history 1 of “the case of participating in at least one of Saturday and Sunday meetings almost every week in the past 8 weeks” and the history 2 of “the case of participating in Wednesday meetings almost every week”.

As is apparent from FIGS. 12, areas of the fuzzy sets resulting from the fuzzy equivalence operations with respect to a combination of the model rule 1 and the history 1 and a combination of the model rule 2 and the history 2 are larger than those of other combinations of the rules and the histories.

In view of this, the availability estimation unit 33 defines the matching degree of the model rule and the history as “an area of the fuzzy set resulting from the equivalence operation of the model rule fuzzy set and the history fuzzy set”. The availability estimation unit 33 determines, out of a fuzzy set representation group of previously prepared model rules, a model rule having a maximum matching degree with the history to be an availability estimation rule with respect to the fuzzy set representation of the client's meeting participation history during a certain set period.

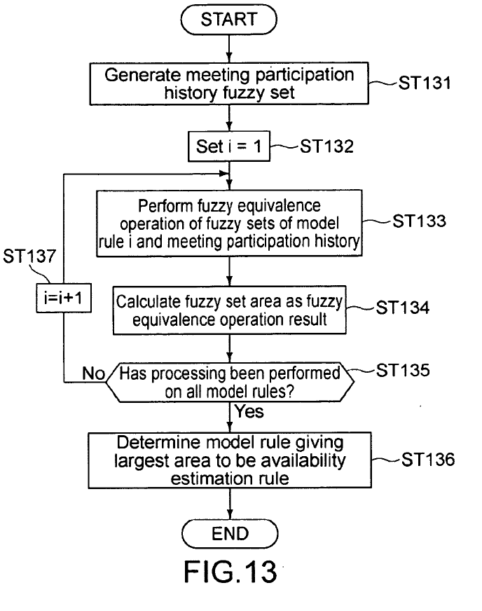

FIG. 13 is a flowchart showing a process flow of determining the availability estimation rule. It should be noted that the availability estimation unit 33 performs a preprocessing of defining the fuzzy set of the model rule group as described above.

As shown in FIG. 13, the availability estimation unit 33 obtains the meeting participation history from the meeting history database 42, to generate a meeting participation history fuzzy set (Step 131). Subsequently, the availability estimation unit 33 sets a counter value i of the model rule to 1 (Step 132), and performs a fuzzy equivalence operation of the fuzzy set of the model rule i and the fuzzy set of the meeting participation history (Step 133).

Next, the availability estimation unit 33 calculates an area of the fuzzy set obtained as a fuzzy equivalence operation result (Step 134). The availability estimation unit 33 judges whether the processings of Steps 133 and 134 have been performed on all the model rules (Step. 135). If a target model rule remains (No), the availability estimation unit 33 increments the counter value i by 1 (Step 137) and repeats the processings of Steps 133 and 134.

When judging that the processings with respect to all the model rules have been completed (Yes), the availability estimation unit 33 determines a model rule providing a larger area than any other calculated areas to be the availability estimation rule (Step 136).

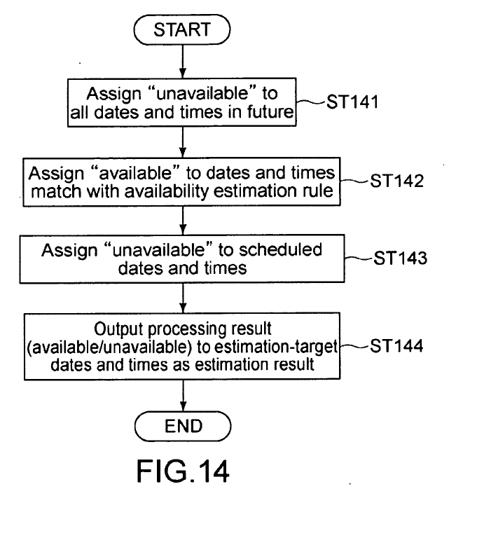

FIG. 14 is a flowchart showing a process flow of estimating the availability using the availability estimation rule determined.

As shown in FIG. 14, the availability estimation unit 33 first performs an initial processing of assigning “unavailable” to each day in the future (Step 141). Next, the availability estimation unit 33 assigns “available” to days in the future that match with the availability estimation rule determined (Step 142).

Subsequently, the availability estimation unit 33 refers to the scheduler 44, to thereby assign “unavailable” to dates on which the user already has plans (Step 143). Then, the availability estimation unit 33 outputs a result of the above processings (i.e., “available” or “unavailable”) with respect to estimation-target dates as an availability estimation result (Step 144).

In the above description, a method of determining the availability estimation rule regarding dates has been described. This method can be also applied for determining an availability estimation rule regarding times.

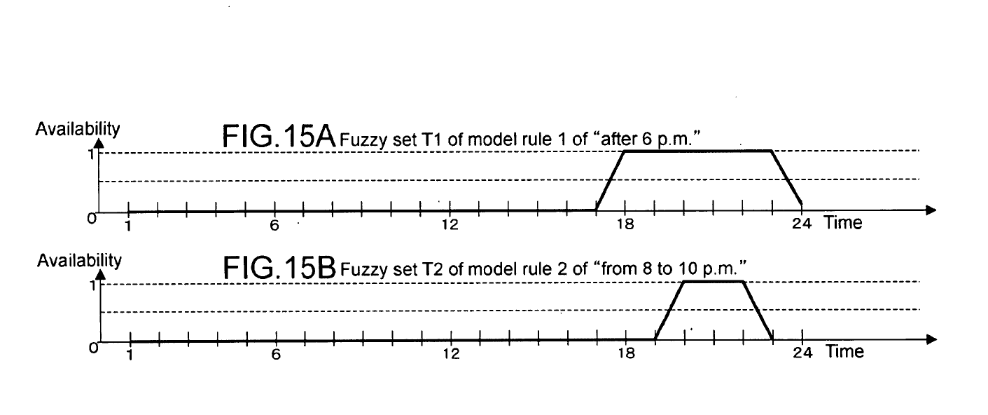

For example, fuzzy sets of a model rule T1 “available after 8 p.m.” and a model rule T2 “available from 8 to 10 p.m.” are considered. FIG. 15 are diagrams showing fuzzy set representations of the model rules T1 and T2, respectively.

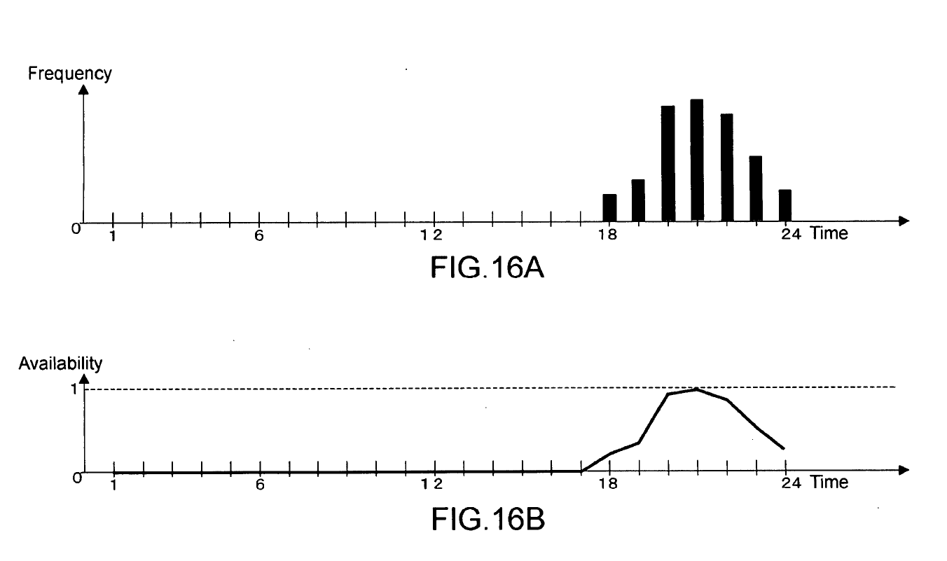

For a fuzzy representation of a past history of meeting participation times, a method in which a histogram created using samples of participation times in the history is normalized in a range of [0, 1] to generate the representation, or a method in which an occurrence probability of a meeting participation event with respect to times is subjected to a model approximation using a Gaussian distribution whose height is 1 to obtain a fuzzy set nay be used. For example, FIG. 16 show a histogram representation in a case where the past history of the meeting participation times shows that the user most often appears in a period of 8 to 10 p.m. (FIG. 16A) and a fuzzy set generated therefrom (FIG. 16B). For a calculation of a matching degree of the model rule and the history, the above-described method for the availability estimation processing regarding dates can also be used, so a detailed description thereof will be omitted.

It should be noted that, in the above description, availabilities of the dates and times are considered independently. However, the availabilities regarding the dates and times may be related to each other in some cases like a case of being “available in the daytime on Saturday and Sunday” and “available on weeknights”. In this case, the availability estimation unit 33 forms a rule with a fuzzy set in which dates and times are set to its abscissa axis, and determines the availability estimation rule through the same approach as above.

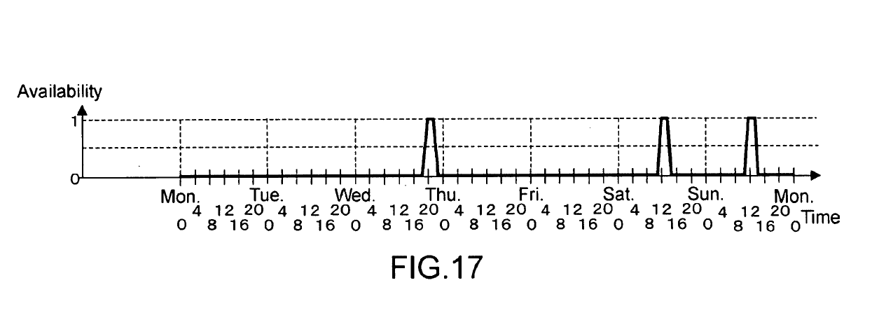

For example, FIG. 17 shows a fuzzy set showing a model rule of being “available from 8 to 10 p.m. on Wednesday and from 12 to 2 p.m. on weekends”. In this case, the availability estimation unit 33 represents the past meeting participation dates and times as the fuzzy sets in the same manner as described above, and performs the equivalence operation on them, thereby making the availability estimation possible.

Referring to the flowchart of FIG. 6 again, upon completion of the availability estimation processings, the CPU 11 estimates the desired meeting place range by the meeting place range estimation unit 34 (Step 64). Hereinafter, a description will be given on the desired meeting place range estimation processings in detail.

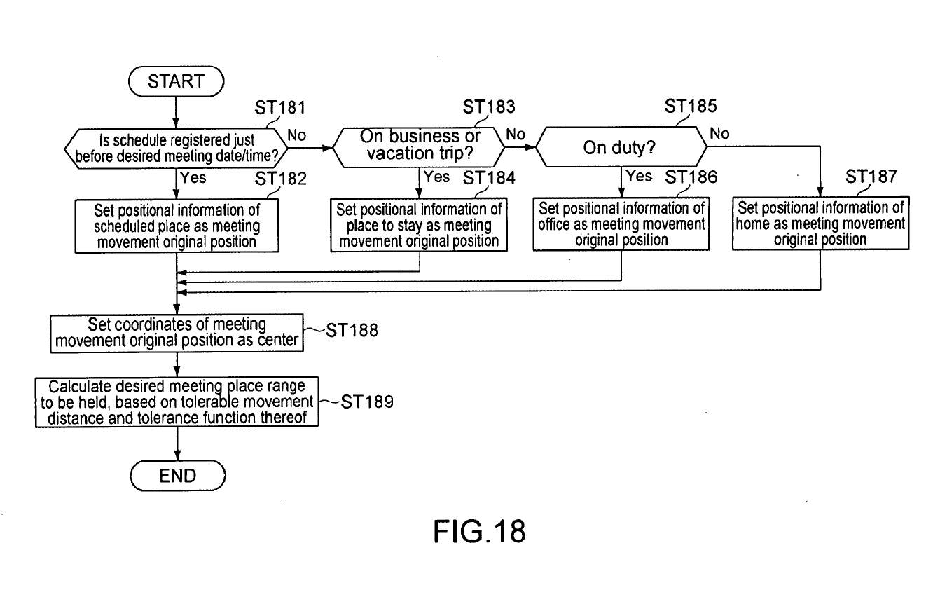

FIG. 18 is a flowchart showing a process flow of the desired meeting place range estimation.

As shown in FIG. 18, the meeting place range estimation unit 34 first arranges places (meeting movement original position) where the clients are just before the desired date and time estimated by the availability estimation unit 33 (Steps 181 to 187). The meeting place range estimation unit 34 refers to the scheduler 44 to judge whether place information of another plan that is set just before the desired meeting date and time is registered (Step 181). When it is judged that the place information is registered (Yes), the place is set as the meeting movement original position (Step 182).

When it is judged that no plan is registered in the scheduler 44 (No), the meeting place range estimation unit 34 judges whether the desired meeting date and time fall within a scheduled period of a business trip or a vacation trip (Step 183). When the desired meeting date and time fall within the scheduled period of the business or vacation trip (Yes in Step 183), a place to stay during the trip is set as the meeting movement original position (Step 184).

In Step 183, when the desired meeting date and time do not fall within the scheduled period of the business or vacation trip (No), the meeting place range estimation unit 34 judges whether the user is on duty or off duty on the desired meeting date and time (Step 185). When judging that the user is on duty, the meeting place range estimation unit 34 sets user's office positional information as the meeting movement original position (Step 186), and when judging that the user is off duty, the meeting place range estimation unit 34 sets user's home positional information as the meeting movement original position (Step 187).

In this case, the positional information is expressed by positional coordinates. For example, if a GPS (Global Positioning System) is provided to the client 1, the meeting place range estimation unit 34 obtains the client's positional coordinates from the GPS. When the GPS cannot be used, the meeting place range estimation unit 34 obtains the client's positional coordinates by specifying the positional coordinates based on a registered address in the scheduler 44 or the like.

Subsequently, the meeting place range estimation unit 34 estimates the desired meeting place range based on a distance by which the user of the client 1 can move and the positional information of the meeting movement original position.

First, the meeting place range estimation unit 34 estimates a tolerable movement distance. Here, the tolerable movement distance is estimated based on an average movement distance from the meeting movement original position to the meeting place, which is calculated from (1) information through the direct input from the client or (2) information on meetings that the user has attended.

In the case of the above item (1), the meeting place range estimation unit 34 causes the user to directly input the tolerable movement distance through the operation input unit 14 of the client 1. For example, the user may directly input values of X and Y in “less than X km” or “from X to Y km”, or may select from options such as “less than km”, “from 5 to 10 km”, and “more than 5 km”.

In the case of the above item (2), the meeting place range estimation unit 34 refers to the past meeting participation history from the meeting history database 42, and calculates movement distances of the past meetings in the past meeting history from the positional coordinates of the meeting movement original positions and of the meeting places, to thereby obtain an average value thereof as the tolerable movement distance. In this case, when the meeting participation history management unit 39 has calculated and stored the movement distance in advance at the time of updating the history data, the movement distance stored is directly referred to.

Next, the meeting place range estimation unit 34 sets the positional coordinates of the meeting movement original position as a center (Step 188), and calculates, as the desired meeting place range, a coordinate region satisfying the tolerable movement distance from the center (Step 189).

For the desired meeting place range, a representation in which a real value ranging from 0 to 1 that indicates a tolerance is assigned to respective coordinates is used. The tolerance is 1.0 within the tolerable movement distance, and is defined by a function in which the tolerance monotonously decreases from 1 to 0 with a predetermined foot width as it distances from the top and bottom ends of the tolerable movement distance.

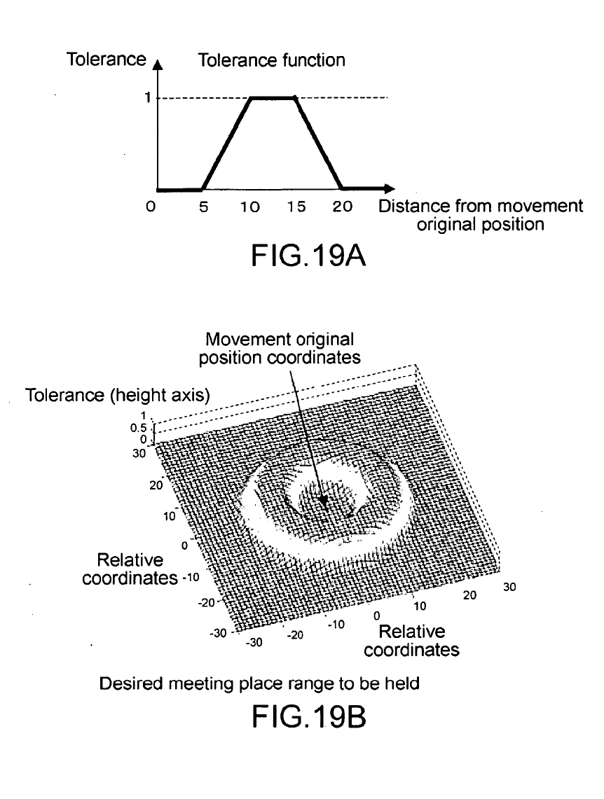

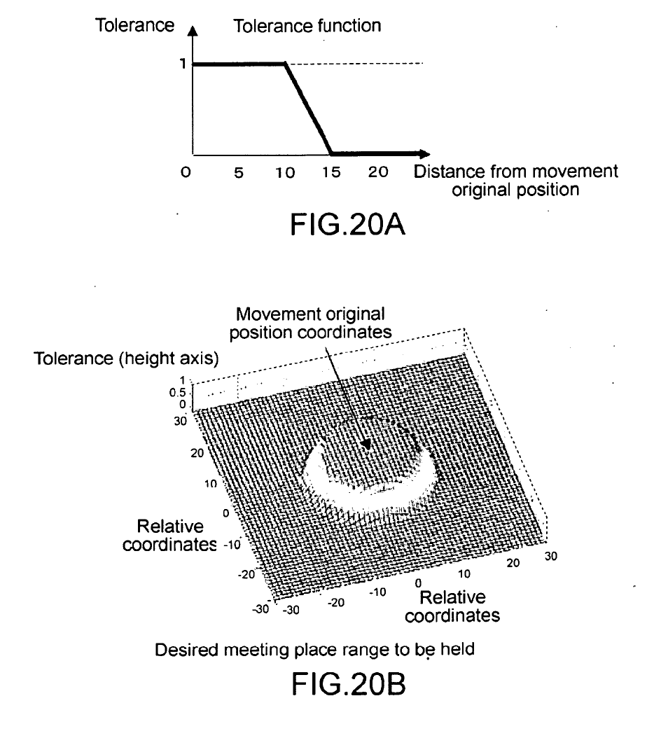

FIGS. 19A and 20A are diagrams each showing an example of the tolerance function. FIGS. 19B and 20B are diagrams each showing an example of the desired meeting place range using the tolerance function. In FIG. 19, the tolerant movement distance is set to 10 to 15 km and the foot width is set to 5 km. In FIG. 20, the tolerable movement distance is set to 0 to 10 km and the foot width is set to 5 km.

Referring to the flowchart of FIG. 6 again, upon completion of the processings of desired meeting place range estimation, the CPU 11 generates meeting member candidates by the meeting member candidate generator 35 (Step 65).

Unlike a general conference arrangement system, in a context of the arrangement of the private meeting such as a drinking party to which the system according to the present invention may be applied, there seems to be a demand for a system that allows an unexpected, fresh, and extraordinary arrangement in a meeting arrangement, in particular, a meeting member arrangement, and creates a situation for enjoying such an arrangement.

In order to implement such system features, the meeting member candidate generator 35 refers to the meeting history database 42, for example, and assigns a higher selection probability to a person who has been less frequently selected as the meeting member in not too distant a past (from among the other clients 1), to perform a weighted random selection.

Further, the meeting member candidate generator 35 can give an instruction of refinement and expansion of the meeting member candidates by the user directly inputting the instruction regarding the meeting members through the operation input unit 14.

For example, the meeting member candidate generator 35 generates instruction options of the refinement and expansion of the meeting members based on the friendship attribute labels such as “anybody is OK”, “only close friends are OK”, “close friends and friends are OK”, “close friends, friends, and acquaintances are OK”, “close friends, friends, and acquaintances of close friends, friends, and acquaintances are OK”, and causes the clients to select one of the options.

For example, when the label of “only close friends are OK” is selected, the meeting member candidate generator 35 picks only persons whose friendship attributes are close friends from the generated meeting member candidates and overwrites and updates the meeting member candidates. When the label of “close friends, friends, and acquaintances are OK” is selected, the meeting member candidate generator 35 picks only persons whose friendship attributes are close friends, friends, or acquaintances and overwrites and updates the meeting member candidates. When the label of “close friends of close friends and friends are OK” is selected, the meeting member candidate generator 35 picks only persons whose friendship attributes are close friends or friends from the meeting member candidates, and appends a label of “your close friends are OK” as an expansion instruction with respect to the candidates, to overwrite and update the meeting member candidates. When the label of “anybody is OK” is selected, the meeting member candidate generator 35 appends a label of “your acquaintances are OK” as the expansion instruction with respect to all the persons of the meeting member candidates, to overwrite and update the meeting member candidates. The expansion instruction is processed by the server 2 (as described later).

Referring to the flowchart of FIG. 6 again, upon completion of the meeting member candidate generation processings, the CPU 11 generates the desired meeting information by the desired meeting information generator 36 (Step 66). That is, the desired meeting information generator 36 collectively processes, into a data structure, the information items such as the desired meeting date and time, the desired meeting place range, and the meeting member candidates generated by the availability estimation unit 33, the meeting place range estimation unit 34, and the meeting member candidate generator 35, respectively, and outputs the data structure to the desired meeting information transmission unit 37 as the desired meeting information.

As described above, the desired meeting information may be directly input by the user through the operation input unit 14 of the client 1. That is, when the client directly inputs the desired meeting date and time, the desired meeting place range, and the meeting member candidates, the desired meeting information generator 36 preferentially transmits the desired meeting information to the desired meeting information transmission unit 37. As a result, it is possible to deal with a case where the client desires to use this system even when a meeting is arranged with a solid intension.

Upon generation of the desired meeting information, the CPU 11 transmits the desired meeting information to the server 2 as appropriate by the desired meeting information transmission unit 37 and the communication unit 15.

The processings as described above are executed on the client 1 side. Next, processings on the server 2 side will be described.

First, the CPU 21 of the server 2 receives the desired meeting information that has been transmitted from each of the clients 1 (Step 68) by the communication unit 25. Then, the CPU 21 temporarily buffers the desired meeting information of the clients 1 by the client desired meeting information buffer unit 52 (Step 69).

Next, the CPU 21 generates the matching client group from the meeting member candidates in the desired meeting information of the clients 1 by the client desired meeting information matching unit 53 (Step 71). Hereinafter, processings of creating the matching client group will be described in detail. In the following description, the client 1 to be a processing target of the desired meeting information is denoted by Ci, and the meeting member candidate information in the desired meeting information of the client of Ci is denoted by ListCi. A processing with respect to Ci will be explained as an example. Here, ListCi is a meeting participation candidate list desired by Ci as described above. Elements of ListCi are other clients 1, and ListCi forms a subset of a set of all the clients managed by the server 2.

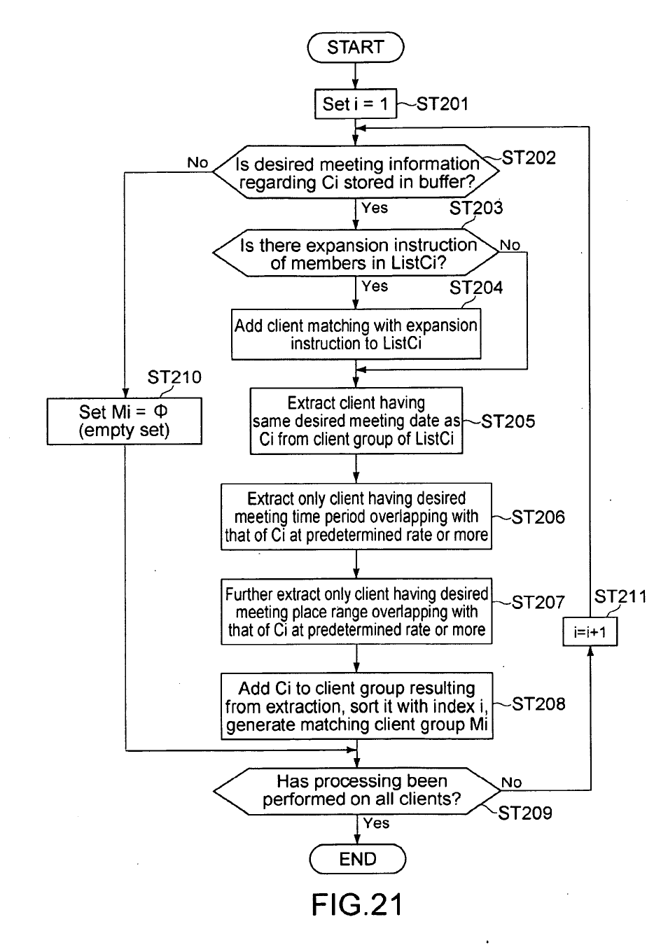

FIG. 21 is a flowchart showing a process flow of creating the matching client group.

First, as shown in FIG. 21, the client desired meeting information matching unit 53 sets the counter value i of the client 1 to 1 (Step 201), and judges whether the desired meeting information on Ci is buffered in the client desired meeting information buffer unit 52 (Step 202).

When judging that the desired meeting information on Ci is buffered (Yes), the client desired meeting information matching unit 53 judges whether ListCi contains the expansion instruction of the members (Step 203). When judging that the expansion instruction is contained (Yes), the client desired meeting information matching unit 53 adds a client who is a meeting member candidate matching with the expansion instruction to ListCi (Step 204). For example, in a case where ListCi contains an element of a client Cj, and an expansion instruction of “your friends are OK” is given to Cj, the client desired meeting information matching unit 53 inquires the client friendship model management unit 51 of the friendship model of Cj. Based on the friendship model of Cj, the client desired meeting information matching unit 53 performs, for example, a random selection of clients whose friendship attributes are “friends” or “close friends” with Cj and adds them to ListCi. The client desired meeting information matching unit 53 performs the above operations on all the elements (clients) in ListCi.

Next, the client desired meeting information matching unit 53 extracts, out of the element clients of ListCi modified (elements added) through the above process, a client group matching with (having a common range of values) the desired meeting date and time and desired meeting place range of the desired meeting information of Ci (matching processing).

As the matching processing, the client desired meeting information matching unit 53 extracts clients in ListCi whose desired meeting dates are the same as that of Ci (Step 205), extracts only clients whose desired meeting times (time periods) overlap that of Ci by a predetermined rate or more (e.g., 50% or more of the desired meeting time period of Ci) out of the clients extracted in Step 205 (Step 206), and extracts clients whose desired meeting place range overlaps that of Ci by a predetermined rate or more (e.g., 25% or more of the desired meeting place range of Ci) out of the clients extracted in Step 206 (Step 207).

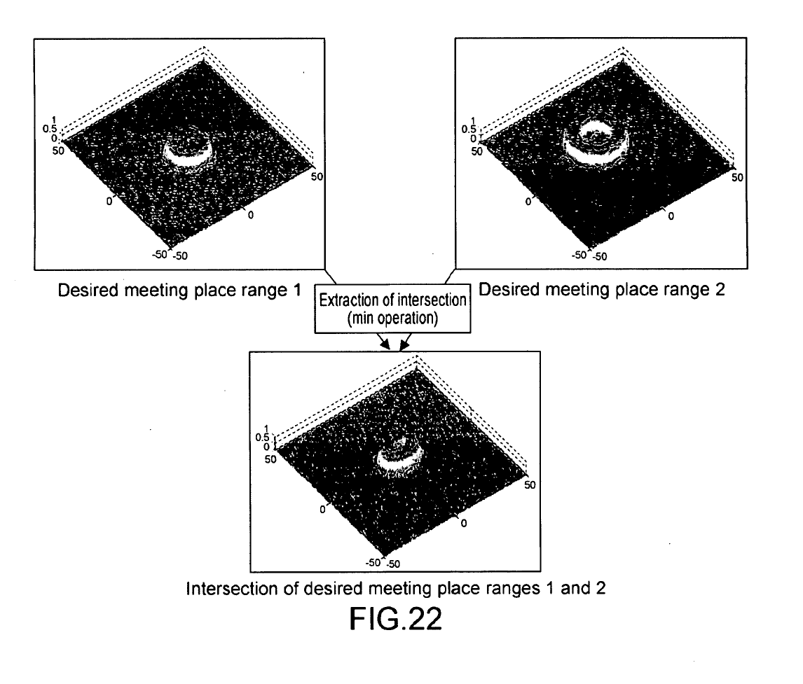

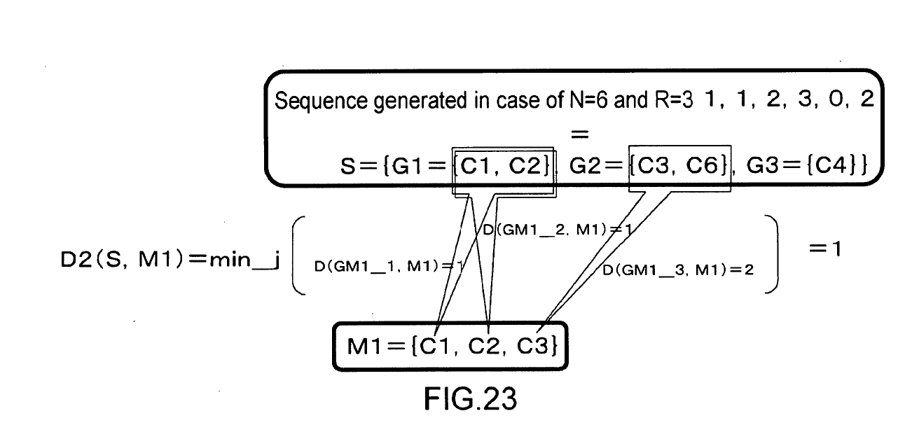

FIG. 22 is a conceptual diagram showing the matching processing of the desired meeting place range in Step 207. As shown in FIG. 22, an intersection of a desired meeting place range 1 of the client Ci and a desired meeting place range 2 of the client Cj is extracted through a min operation using a min function, for example. Here, a proportion of the intersection with respect to the desired meeting place range 1 is obtained as a volume ratio.

As a result of the above matching processing, the matching client group is extracted for the client Ci. The client desired meeting Information matching unit 53 adds Ci to the client group and sorts it using indexes, to generate sets as a matching client group Mi and store the same (Step 208).

Assuming that, as a matching result with respect to a client C1, a matching client group {C2, C5, C9, C10} is extracted, for example. C1 is added to the group, and the group is sorted using indexes, to obtain M1={C1, C2, C5, C9, C10} as the “matching client group” of C1.

The client desired meeting information matching unit 53 increments the counter value i and repeatedly performs the above processings, to thereby obtain a matching client group Mi with respect to each client Ci (Steps 209 and 211).

In Step 202, when judging that the desired meeting information on Ci is not buffered (No), the client desired meeting information matching unit 53 sets Mi to φ (empty set) (Step 210).

Referring to the flowchart of FIG. 6 again, the CPU 21 generates, by the optimal meeting client group set generation unit 54, such an optimal meeting client group set that the clients are not contained redundantly and as many requests of the clients (desired meeting information) as possible are met, from the matching client groups of all the clients obtained as described above (Step 71). Here, the optimal meeting client group set generation unit 54 assumes that one client cannot participate in a plurality of meetings held at the same time, and causes an element (client) to be exclusive among the optimal meeting client groups. Hereinafter, a description will be given on processings of generating the optimal meeting client group set in detail.

Here, a description will be given on problems that should be solved to generate the optimal meeting client group set.

First, a distance D between two client groups is introduced. A description will be given on a case where the client groups are used as character strings and a Levenshtein distance is introduced as a distance scale for indicating how much two character strings differ from each other.

The Levenshtein distance is given as a minimum count required for converting one character string into another character string by insertion, deletion, or substitution of characters.

For example, a Levenshtein distance D (Mi, Mj) between the client group Mi={C1, C2, C5, C9, C10} and a client group Mj={C1, C5, C7, C10} is determined to be 2, because at least two steps of “inserting C2 to Mj and substituting C9 for C7” are required to convert Mj into Mi. In this case, elements of Mi and Mj are sorted using indexes in advance, that is, sorted in an ascending order of client IDs.

Next, a description will be given on a method of generating an arbitrary set S={G1, . . . , GR} constituted of R client groups G1, . . . , GR at a maximum, in a case where the number of clients is N, the client groups G1, . . . , GR each having elements exclusive of each other.

First, a sequence having a length of N and having elements obtained by select-on from integers of 0 or more and R or less at random is generated. Then, the n-th number of the sequence is set as an ID of the client group to which a client Cn belongs. For example, in a case of R=3 and N=6, assuming that a sequence generated is 3, 3, 1, 2, 0, 1, a client group set S={G1, G2, G3} in which G1={C3, C6}, G2={C4}, and G3={C1, C2} can be generated. C5 does not belong to any client group.

Further, for example, assuming that a sequence is 2, 2, 1, 1, 0, 1, the client group set S={G1, G2, G3} in which G1={C3, C4, C6}, G2={C1, C2}, and G3=φ (empty set) is generated. C5 does not belong to any client group. Because G3 is an empty set, two client groups having elements exclusive of each other are created.

A distance D2 (S, Mi) between the arbitrary client group set S={G1, . . . , GR} generated as described above and the matching client group Mi of the arbitrary client Ci is defined as follows.

D2(S, Mi)=min_{—}j(D(GMi_{—}j, Mi)) (5)

In the above expression, GMi_j is a client group that belongs to S having a j-th element (client) of Mi, and min_j is an operation having a minimum value of j. For example, let us consider calculating D2(S, M2) when a sequence of 1, 1, 2, 3, 0, 2 generated in a case of N=6 and R=3 is used, S={G1={C1, C2}, G2={C3, C6}, G3={C4}} is generated, and a matching client group M1 of the client C1 is M1={C1, C2, C3}. GM1_1=G1, GM1_2=G1, and GM1_3=G2 are established, and the Levenshtein distance D(GM1_j, M1) between each of them and M1 is 1, 1, and 2. Therefore, from the above expression (5), D2(S, M1)=min_j(1, 1, 2)=1 is obtained. FIG. 23 shows this example.

Further, a distance D3(M, S) between the matching client group set M={M1, . . . , MN} of all the clients C1 to CN and an arbitrary S is defined as follows.

D3(M, S)=Σi(D2(S, Mi)) (6)

where i=1, . . . , N

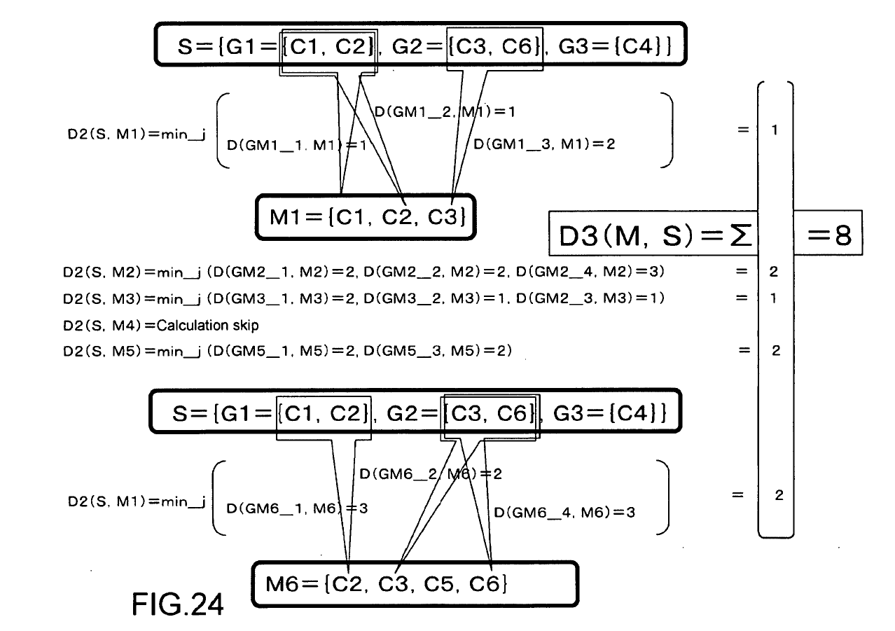

For example, assumed is a case of calculating D3(M, S) with respect to S={G1={C1, C2}, G2={C3, C6}, G3={C4}} used in the above example, in a case of M={M1={C1, C2, C3}, M2={C1, C2, C5, C6}, M3={C1, C3, C6}, M4=φ, M5={C2, C5, C6}, M6={C2, C3, C5, C6}. As in the above calculation example, D2(S, M1)=1 is obtained. When the other elements of M are calculated in the same way, D2(S, M2)=2, D2(S, M3)=1, D2(S, M4)=calculation skipped (because of M4=φ, D2(S, M5)=2, and D2(S, M6)=2 are obtained. Thus, according to the above expression (6), D3(M, S)=1+2+1+2+2=8 is obtained. FIG. 24 is a diagram showing this calculation process. In FIG. 24, the calculation process of only M1 and M6 is shown in detail.

Here, the distance scale D3 (M, Sk) (k=1, 2) defined by the above expression (6) is used as a scale for determining which of arbitrary S1 or S2 having elements exclusive of each other, represents the set M of the matching client group of all the clients better, that is, which of them more satisfies requests (desired meeting information) of the clients.

When D3(M, S1)>D3(M, S2) is established, more “cost” (which can be regarded as “resignation” or “compromise”) is required in a case where the client group set represented by S1 is more distant from M, that is, the client group set (desired meeting members) desired by the clients is changed to S1. Therefore, the smaller D3 value Sk has, the more the requests of all the clients are satisfied.

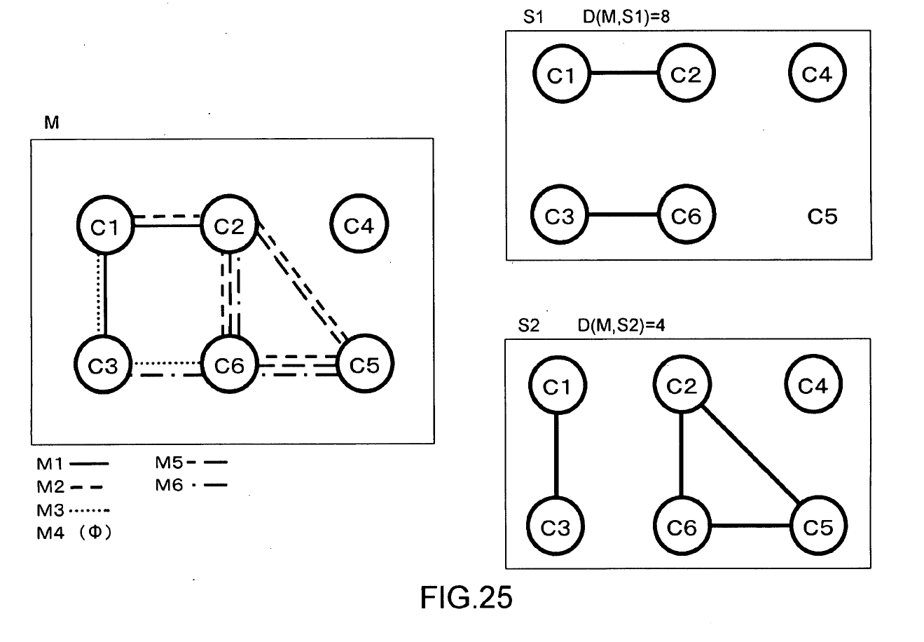

For example, in a case of S1={G1={C1, C2}, G2={C3, C6}, G3={C4}} and S2={G1={C1, C3}, G2={C2, C5, C6}, G3={C4}} with respect to M used in the above example, D3(M, S3)=8, D3(M, S2)=4 are obtained. FIG. 25 is a diagram showing distances between S1 and M1 and between S2 and M1 as graph representations. As shown in FIG. 25, it can be visually recognized that S2 has a more similar shape to M than S1.

From the above description, the problem to be solved can be formulated as such an optimization problem that “S ⊂S⁻ in which the distance D3 from M is minimum is obtained from among an entire set S⁻ of the client group sets having up to R elements exclusive of each other”. A solution (approximate solution) of the optimization problem is a client group set that arranges the desired meeting members desired by the clients so as not to be modified as much as possible and constitutes a meeting group so as not to include members redundantly in the meetings.

There is no analytic solution method for solving the above optimization problem, but a combinational optimization method typified by a genetic algorism (GA) can be used to obtain the approximate optimal solution.

In the genetic algorism, in a space where the solution of the optimization problem is chromosomally-encoded (GA operation 0), the following operation is performed.

First, an initial chromosome population (initial population) is generated at random (GA operation 1). The population is subjected to a set of operations such as crossing over (GA operation 2), mutation (GA operation 3), calculation of goodness of fit (GA operation 4), and reproduction based of the goodness of fit (GA operation 5), and these operations are repeated (GA operation 6). As a result, the entire population is “evolved”. Out of the chromosome population obtained after sufficient repetitive operations, a resultant obtained by decoding a chromosome having the highest goodness of fit becomes the approximate optimal solution of the optimization problem.

Hereinafter, a detailed description will be given on processings of generating an optimal client group set using the genetic algorism. [Definition of Encoding Chromosome (GA Operation 0)]

First, the optimal meeting client group set generation unit 54 defines, with respect to a certain positive integer R, a chromosome representation Sg of S in a case of setting a certain client group set in which elements are exclusive of each other to S as an integer column as an S generation source. For example, a chromosome CH(S)=(3, 3, 1, 2, 0, 1) is a chromosome representation of a client group set S={G1, G2, G3} in which G1={C3, C6}, G2={C4}, G3={C1, C2} are obtained.

[Definition of Foodness of Fit]

Further, the optimal meeting client group set generation unit 54 defines the goodness of fit F(CH(S)) with respect to each chromosome CH(S) as

F(CH(S))=−D3(M, S) (7).

This is a function that takes a negative value such that the goodness of fit decreases as S becomes more distant from M.

[Determination of Value R]

Next, the optimal meeting client group set generation unit 54 determines an upper limit of a set count R of the client group sets having elements exclusive of each other. In a case where the total client count is set to N and a minimum element count of the meeting (minimum participation member count required to hold the meeting) is set to ε, R=FLOOR(N/ε) is determined. Here, FLOOR(x) is a maximum integer that does not exceed x.

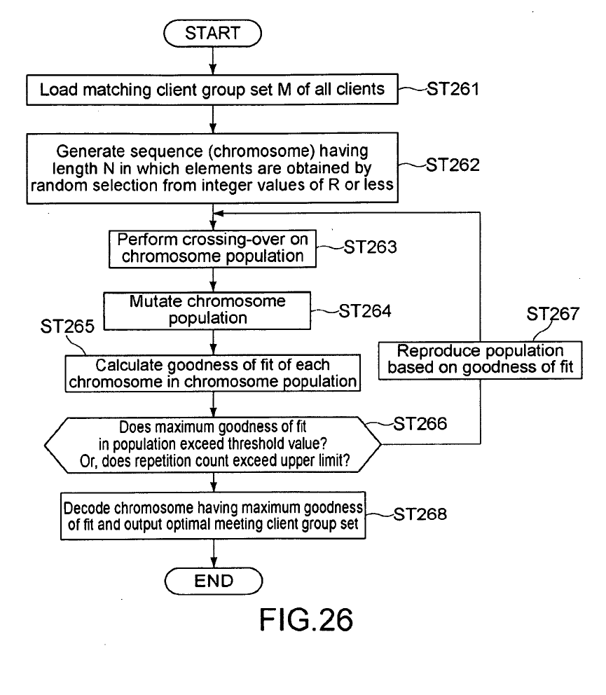

Subsequently, the optimal meeting client group set generation unit 54 executes the process of the above GA operations 1 to 5. FIG. 26 is a flowchart showing the process flow.

First, as shown in FIG. 26, the optimal meeting client group set generation unit 54 loads the generated matching client group set M of all the clients (Step 261).

[Generation of Initial Population (GA Operation 1)]

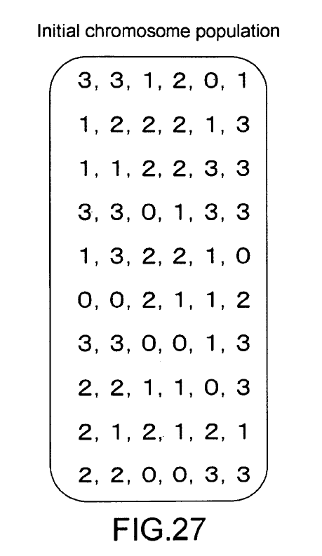

Subsequently, the optimal meeting client group set generation unit 54 generates the initial chromosome population (Step 262). Specifically, the optimal meeting client group set generation unit 54 generates a sequence (chromosome) having a length of N in which elements are obtained through random selection from integer values of 0 or more and R or less, and repeats this operation P times, to generate P initial chromosome populations at random. FIG. 27 is a diagram showing an example of the initial chromosome populations thus generated. P is a size of the initial populations and is desirably set to have a size of about 10³ to 10⁵.

[Crossing Over (GA Operation 2)]

Subsequently, the optimal meeting client group set generation unit 54 stochastically selects a pair of chromosomes to be subjected to crossing over, and entirely exchanges the right-hand side gene sequences of the selected pair of chromosomes with each other at a crossing-over point randomly selected (Step 263).

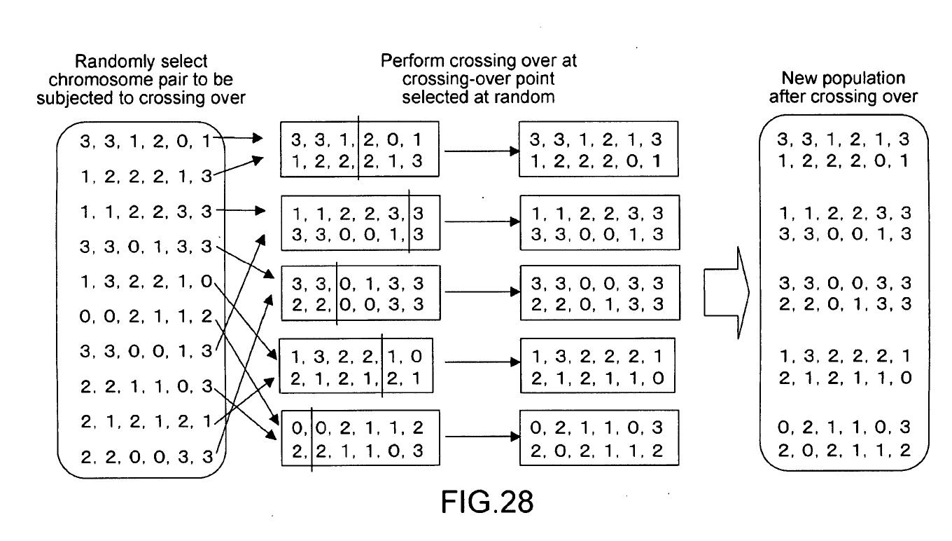

FIG. 28 is a conceptual diagram showing the above operation. As shown in FIG. 28, assuming that CH1=(3, 3, 1, 2, 0, 1) and CH2=(1, 2, 2, 2, 1, 3) are selected as the pair to be subjected to crossing over from among the populations, and a third locus and a fourth locus are selected as the crossing-over points, for example, last three genes (2, 0, 1) of CH1 are exchanged with last three genes (2, 1, 3) of CH2, to thereby generate new chromosomes of CH1*=(3, 3, 1, 2, 1, 3) and CH2*=(1, 2, 2, 2, 0, 1). CH1 and CH2 are overwritten to be CH1* and CH2*, respectively.

[Mutation (GA Operation 3)]

Subsequently, the optimal meeting client group set generation unit 54 randomly replaces a gene with an allele at a certain small probability at each locus of the chromosomes that have been subjected to crossing over (Step 264).

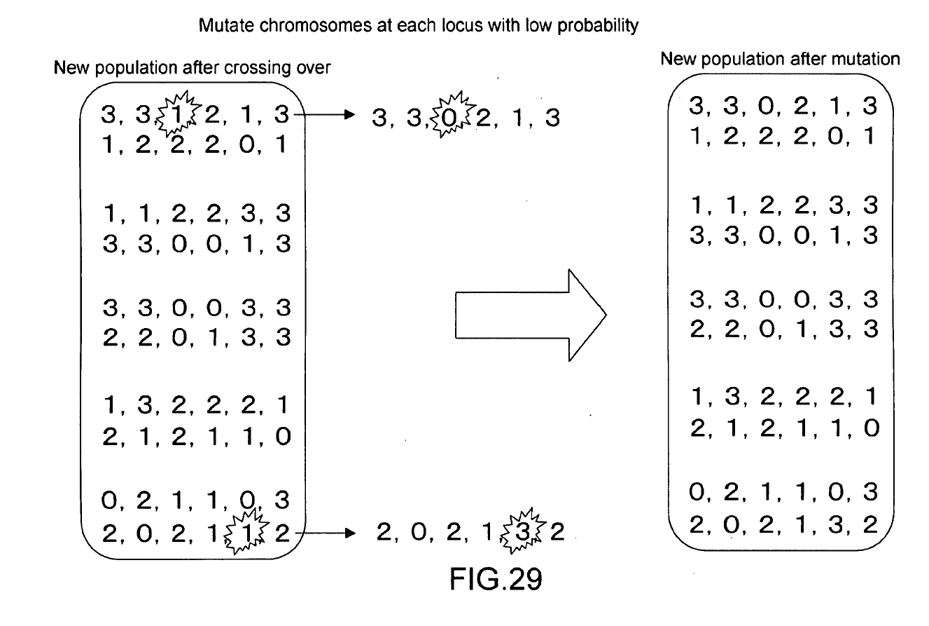

FIG. 29 is a conceptual diagram showing the mutation processing. As shown in FIG. 29, assuming that the third locus of CH1 above is selected as a mutation target, and 0 is randomly selected from the allele (other than 3 out of 0, . . . , R) of the gene (3), CH1=(3, 3, 1, 2, 1, 3) is mutated into CH1**=(3, 3, 0, 2, 1, 3). CH1 is overwritten to be CH**. [Calculation of Goodness of Fit (GA Operation 4)]

Subsequently, the optimal meeting client group set generation unit 54 calculates, according to the above expression (7), the goodness of fit of chromosomes in the populations replaced through crossing over and mutation described above (Step 265). Prior to the calculation, each CH is decoded to be a representation of its client group set S.

[Repetition Termination Judgment]

Subsequently, the optimal meeting client group set generation unit 54 judges whether the maximum goodness of fit, among pieces of goodness of fit of the chromosomes in the population, exceeds a predetermined threshold value or whether a predetermined upper limit repetition count is exceeded (Step 266). When judging that either of the predetermined values is exceeded (Yes), the optimal meeting client group set generation unit 54 terminates the repetition processing, and a client group set S obtained by decoding a chromosome having the maximum goodness of fit is output as an approximate optimal solution S* of the above optimization problem (Step 268).

[Reproduction Based on Goodness of Fit (GA Operation 5)]

When judging that both of the predetermined values are not exceeded in Step 266, the optimal meeting client group set generation unit 54 allows chromosomes having high goodness of fit among the population to grow, and performs processing of causing mid-level chromosomes to remain and low-level chromosomes to die (Step 267).

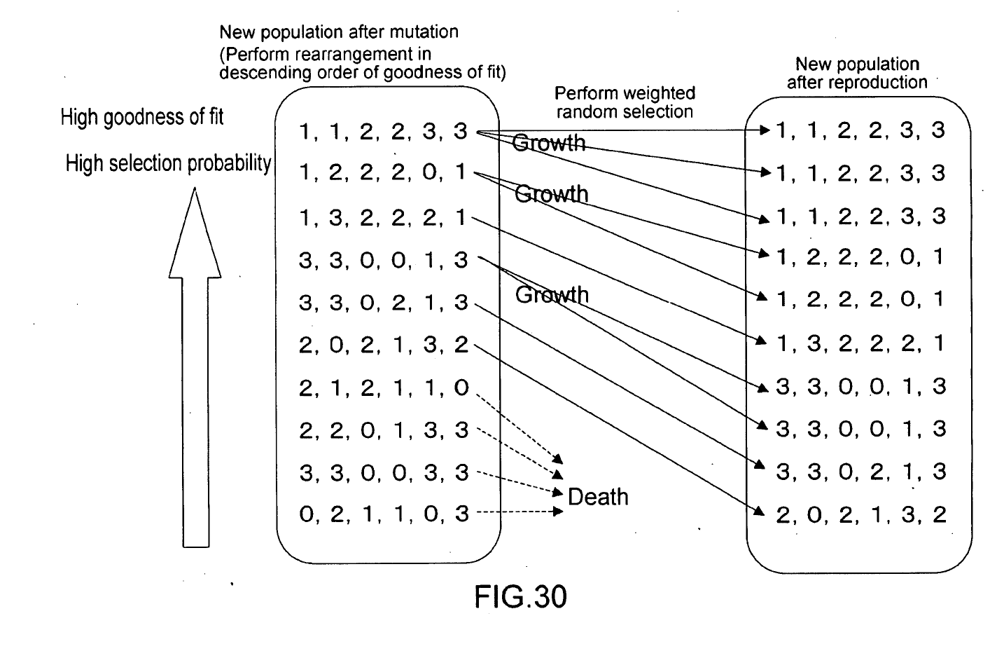

FIG. 30 is a conceptual diagram showing the reproduction processing. As shown in FIG. 30, the optimal meeting client group set generation unit 54 assigns, to each chromosome, a selection weight according to its degree of goodness of fit, and performs an operation of selecting P chromosomes through a weighted random selection. A selection weight (selection probability) W(CHi) of each chromosome CHi according to the degree of goodness of fit is defined as follows.

W(CHi)=F(CHi)/Σj(F(CHj)) (8)

This reproduction processing is repeated until it is judged that either of the predetermined value is exceeded.

The solution S* obtained as a result of the above processing is a solution of such an optimization problem that “S⊂S⁻ in which the distance D3 from M is minimum is obtained from among an entire set S⁻ of the client group sets having up to R elements exclusive of each other”. The solution becomes a client group set that arranges the desired meeting members desired by the clients so as not to be modified as much as possible and constitutes a meeting group so as not to include members redundantly in the meetings. This becomes an output from the optimal meeting client group set generation unit 54.

Referring to the flowchart of FIG. 6 again, the CPU 21 adjusts, by the meeting arrangement unit 55, the desired meeting information of clients who belong to the optimal meeting client groups (hereinafter, referred to as Oi) that are elements of the optimal meeting client group set S* generated by the optimal meeting client group set generation unit 54, and makes a final meeting arrangement (Step 72).

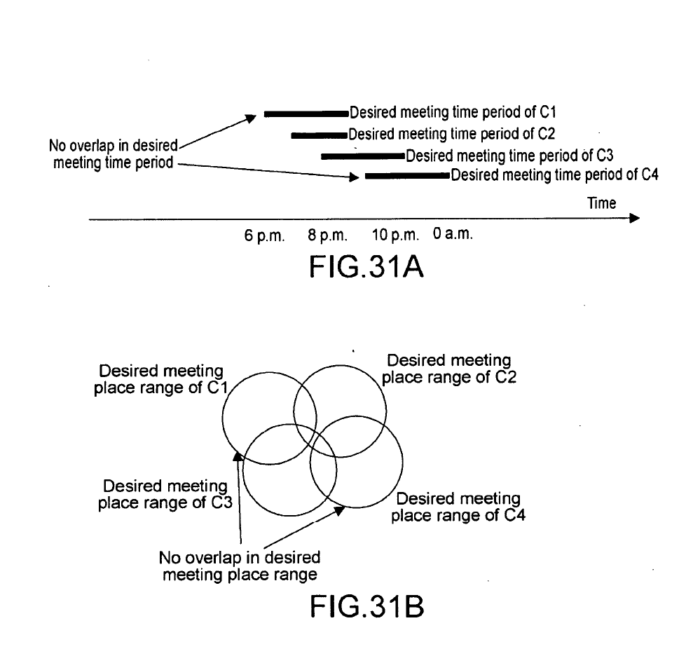

Here, the client groups belonging to Oi have the same desired meeting date. On the other hand, regarding the meeting time period and place range, some client pairs may have an overlap, and other client pairs may not. FIG. 31 are conceptual diagrams showing a case where the optimal meeting client group includes the client pairs having no overlap regarding the meeting time period and place to be held. FIG. 31A is a conceptual diagram regarding the meeting time period to be held, and FIG. 31B is a conceptual diagram regarding the meeting place to be held. In FIGS. 31A and 31B, Oi={C1, C2, C3, C4} is assumed.

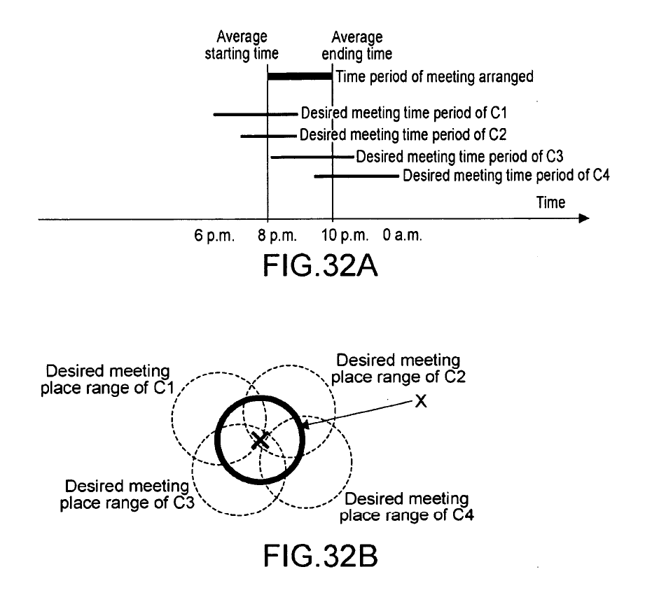

FIG. 32 are conceptual diagrams showing a case where the optimal meeting client group includes the client pairs having no overlap regarding the meeting place to be held. FIG. 32A is a processing conceptual diagram regarding the meeting time period to be held, and FIG. 32B is a processing conceptual diagram regarding the meeting place to be held. In FIGS. 32A and 32B, Oi={C1, C2, C3, C4} is assumed.

As shown in FIG. 32A, regarding the meeting time period, the meeting arrangement unit 55 sets an average starting time of the desired meeting times of all the clients of Oi as the starting time. The ending time is also determined through averaging process in the same way.

As shown in FIG. 32B, the meeting arrangement unit 55 sets, as the meeting place, a place X within a predetermined distance (e.g., 2 km) around a weighted center of a sum of sets of the desired meeting place ranges desired by all the clients of Oi.

For the final meeting arrangement, it is inevitable to determine a place where the members get together. The meeting arrangement unit 55 picks a facility to be a landmark (e.g., station) within the meeting place range and determines the facility as the place where the member get together, for example. The meeting arrangement unit 55 can pick the facility by downloading map information including facility information from a map information website or the like. In a case where a plurality of facilities that can be the place where the members get together exist in the map information, the meeting arrangement unit 55 selects one facility therefrom at random, for example. Alternatively, the meeting arrangement unit 55 may adopts a facility that have been the place where the members get together in the past.

Referring to the flowchart of FIG. 6 again, the CPU 21 distributes, through the meeting arrangement information transmission unit 56, the information on the conclusive meeting date and time and the conclusive place where the members get together to all the clients belonging to Oi. Here, the meeting arrangement information transmission unit 56 can transmit information on the client group (i.e., members invited to participate in the meeting) to which the meeting information is transmitted. However, some service patterns may exert larger effect by concealing the information. For example, the meeting automatic arrangement service can feature such “unpredictability” and “eventuality” that the participants have no way of finding until they get together at the place determined.

With that, the processings on the server 2 side are ended.

The process returns to the processings on the client 1 side again.

The CPU 11 of the clients 1 receives, through the arranged meeting information reception unit 38, the arranged meeting information transmitted from the server 2 (Step 74).

Here, the clients 1 may notify the server of their intentions of participation/nonparticipation. In this case, the server 2 may exclude clients who are nonparticipant from the optimal meeting client group for which the meeting is arranged, and may notify, when an element count of the optimal meeting client group (i.e., the number of clients who may participate in the meeting) is a certain count or less, the clients of cancellation of the meeting.

When the user of the client 1 actually participates in the meeting, the CPU 11 obtains, through the meeting participation history management unit 39, the meeting information (the date and time, the positional information of the meeting place, the immediately preceding positional information (meeting movement original position), the movement distance from the meeting movement original position to the meeting place, and the meeting members) with reference to the information in the scheduler as appropriate, and stores the obtained information in the meeting history database. The information on the meeting members is referred when meeting member candidates are created next time.

Tasks such as making contact for getting together participants of a meeting such as a drinking party, and making coordination on the schedule, meeting place, date and time are a burden for the organizer. Due to the burden, holding a meeting becomes bothersome, resulting in reduction of opportunities to meet acquaintances and alienation with the acquaintances without realizing it. However, by automatically arrange the meeting through the above-described processings of the meeting arrangement system 100 in this embodiment, the burden can be alleviated and the relations with the acquaintances can be further deepened. In addition, the meeting arrangement system 100 automatically provides an opportunity to drink with acquaintances that are not in contact for a long time and can hardly participate in a meeting suddenly arranged. Further, the system has the friendship models and can implements friendship level specification of the members whom each user desires to drink with. Therefore, the system can specify a feature of the meeting desired by the clients, such as a meeting in which the clients desire to drink with only their acquaintances, a meeting in which the clients can know somebody the acquaintances know, and a meeting for different members than usual. If the information of a business or vacation trip is registered in the scheduler, the system can realize an automatic arrangement of a meeting for acquaintances in a place where the client is.

The present invention is not limited to the above embodiment, and various modifications can of course be made within the scope of the present invention.

In the above embodiment, after the meeting arrangement is made for the respective optimal meeting client groups, the server 2 may perform, in addition to notification of the information, recommendation of eating and drinking places, then transmits the recommended places to the respective client groups, coordinates opinions of the clients 1, and determines a conclusive place. After that, the server 2 may perform notification to the clients and electrical reservation on the place. This processing can be executed by obtaining information on the place existing within the meeting place range from a store information providing website by the server 2, for example.

Further, the server 2 receives, from the clients, evaluations on whether the meeting arrangement is good or bad, and may adjust a parameter of friendship calculations of agents in the clients, a parameter of the availability estimation unit 33, a parameter of the meeting place range estimation unit 34, a parameter of the meeting member candidate generator 35 (how to allocate the weights in weighted selection probability), or a parameter of the optimal meeting client group set generation unit 54 in the server (a distance scale or a parameter of the genetic algorism).

Further, the server 2 may randomly select an organizer from the clients 1 as the arranged meeting members, and transmit the information with the arranged meeting information.

In the above embodiment, the availability estimation unit 33 of each of the clients 1 performs matching between the model rule prepared in advance and the past meeting history, to thereby estimate the availability. Alternatively, the following method may be used as the availability estimation method.

### Modification Example 1 with Regard to Availability Estimation

The availability estimation unit 33 may allow the user to directly input the availability estimation rule with respect to the meeting arrangement through the operation input unit 14. For example, the availability estimation unit 33 causes the display unit 16 to display a UI (user interface) for a check box and list selection, and causes the user to select ones from arrangement options regarding a meeting date such as “every day”, “every day (except Saturday and Sunday)”, “every weekend”, “every x (day of the week)”, “the x-th of each month”, “the x-th week of each month”, and “at the beginning, in the middle, or at the end of each month”) and regarding time (e.g., “after x o'clock”, “before x o'clock”, or “x to x o'clock”. Here, “x” is selected from the list. The availability estimation unit 33 provides an estimation result showing “available” for a date and a time in the future that meets a selected condition and “unavailable” for the other dates and times.

### Modification Example 2 with Regard to Availability Estimation

The availability estimation unit 33 performs predictive learning of the availability based on the history of dates and times when the user has participated in the past meetings, and thus may estimate the availability. Hereinafter, a description will be given on this example.

As a representation method of the history of dates when the user has participated in the past meetings, a method of using longitudinal binary data in which a date when a meeting has been held and the user has participated in the meeting is expressed as 1 and a date the user has not participated is expressed as 0 will be explained. For example, when meetings on every Wednesday and Saturday are participated in during two weeks (starting from Monday), |0010010|0010010| is obtained (“|” is inserted as a week separator for easy understanding). When meetings on alternate Fridays are participated in, the data of the month is expressed as |0000100|0000000|0000100|0000000|. From a different point of view, the availability estimation unit 33 learns an interval from “1” to “1” (interval between the participation dates), and predicts the next participation date. The latter case above is a 14-order Markov decision process in which data of at least two weeks is required for predicting the next participation date. For this problem formulation, it is necessary to introduce a learning model capable of dealing with a long context. This can be realized by using, for example, a hidden Markov model or a recurrent neural network as a predictor.

In the above embodiment, the meeting member candidate generator 35 generates meeting member candidates by assigning higher selection probability to a person who has been less frequently selected as the meeting members in the past regardless of the friendship frequency, and performing the weighted random selection. However, as the method of generating the meeting member candidates, the following methods can be considered: (1) a method of assigning higher selection probability to a person having less friendship frequency from the friendship model and performing the weighted random selection, and (2) a method of assigning higher selection probability to a person who has some recent events (e.g., celebratory occasion such as having a baby) and registers, in the scheduler 44 or the mailer 43 of the client 1, such information that “I'd Like to hold a meeting one of these days for that occasion”, and performing the weighted random selection.

In the case of the method (2), the meeting member candidate generator 35 detects an event by an analysis method such as a text analysis and a keyword analysis, and then detects another person who has had the event as the weighted random selection target.

In the above embodiment, the client 1 is the portable electronic apparatus such as a mobile phone, but may instead be a stationary electronic apparatus such as a desktop PC and AV equipment.

What is claimed is:

1. A client apparatus, comprising:
a communication means for communicating with a server apparatus and a plurality of other client apparatuses;
a first generation means for generating, based on communication history information with the plurality of other client apparatuses by the communication means, friendship information indicating a friendship between a first user of the client apparatus and each of second users of the plurality of other client apparatuses;
a storage means for storing schedule information including scheduled date/time information and scheduled place information of a scheduled event for the first user and meeting history information including date/time history information, place history information, and member history information of a meeting arranged in a past;
a second generation means for generating desired meeting date/time information of the first user based on the scheduled date/time information and the date/time history information stored;
a third generation means for generating desired meeting place information of the first user based on the scheduled place information stored, the place history information stored, and desired meeting date/time information generated;
a fourth generation means for generating meeting member candidate information indicating candidates of client apparatuses to be meeting members based on the friendship information generated; and
a control means for controlling the communication means to transmit, to the server apparatus, the desired meeting date/time information, the desired meeting place information, and the meeting member candidate information generated, as desired meeting information, and controlling the communication means to receive arranged meeting information arranged by the server apparatus based on the desired meeting information transmitted.

2. The client apparatus according to claim 1,
wherein the storage means stores a communication count and a communication t me with the plurality of other client apparatuses as the communication history information,
wherein the first generation means includes
means for calculating a friendship frequency between the client apparatus and each of the other client apparatuses by assigning a first weighting factor to a first communication count in an off-duty period of the first user and assigning a second weighting factor smaller than the first weighting factor to a second communication count in an on-duty period of the first user, out of the communication count in a first predetermined period with the plurality of other client apparatuses, and adding the first communication count and the second communication count that are assigned the first weighting factor and the second weighting factor, respectively, and
means for calculating a rate of a friendship frequency with the other client apparatuses targeted for the calculation of the friendship frequency with respect to a sum of the friendship frequency with each of the other client apparatuses, the rate of the friendship frequency being calculated as a friendship degree between the first user and the second user, and
wherein the control means controls the communication means to transmit, to the server apparatus, the friendship degree calculated for each of the plurality of other client apparatuses as a part of the friendship information.

3. The client apparatus according to claim 1,
wherein the storage means stores a plurality of rule information items regarding a date and a time when the first user is capable of participating in the meeting, and
wherein the second generation means includes
means for comparing the date/time history information stored with the plurality of rule information items,
means for determining, based on a result of the comparing, a rule information item having highest similarity to the meeting history information as estimation rule information and estimating the date and time when the first user is capable of participating in the meeting based on the estimation rule information,
means for comparing the date and time estimated with the scheduled date/time information stored, and
means for generating, based on a result of the comparing, a date and a time unmatched with the scheduled date/time information as the desired meeting date/time information.

4. The client apparatus according to claim 3,
wherein the second generation means sets, in a membership function in which an abscissa axis represents dates and times and an longitudinal axis represents membership values, the plurality of rule information items as a first fuzzy set and the date/time history information as a second fuzzy set, calculates an equivalence of the first fuzzy set and the second fuzzy set, determines a rule information item having a largest area of a third fuzzy set as a result of calculation of the equivalence, to be the estimation rule information.

5. The client apparatus according to claim 1,
wherein the second generation means includes
means for learning the date/time history information stored and estimating, based on a result of the learning, a date and a time when the first user is capable of participating in the meeting,
means for comparing the date and time estimated with the scheduled date/time information stored, and
means for generating, based on a result of the comparing, a date and a time unmatched with the scheduled date/time information as the desired meeting date/time information.

6. The client apparatus according to claim 1,
wherein the third generation means includes
means for determining, based on the scheduled place information, a scheduled place of a scheduled event just before a date and a time included in the desired meeting information generated, to be a movement original position of the meeting, and
means for generating, as the desired meeting place information, tolerable movement distance range information indicating a distance range from the movement original position determined that is capable of being tolerated by the first user based on arranged place information and movement original position information of past meetings included in the place history information.

7. The client apparatus according to claim 6,
wherein the third generation means generates, as the tolerable movement distance range information, a tolerance function in which a first tolerance is assigned to positional coordinates existing in the tolerable movement distance range from the movement original position determined and a second tolerance smaller than the first tolerance is assigned to positional coordinates existing in a predetermined distance range out of the tolerable movement distance range.

8. The client apparatus according to claim 2,
wherein the fourth generation means generates the meeting member candidate information by performing a weighted random selection such that other client apparatuses having a lower friendship frequency calculated are more highly weighted, to select the other client apparatuses.

9. The client apparatus according to claim 3,
wherein the fourth generation means generates, based on the meeting history information, the meeting member candidate information by performing a weighted random selection such that other client apparatuses that have been set as the meeting member smaller number of times in a second predetermined period is more highly weighted, to select the other client apparatuses.

10. The client apparatus according to claim 2,
wherein the storage means stores message information of an e-mail transmitted to/received from the other client apparatuses through the communication means,
wherein the fourth generation means includes
means for judging whether a predetermined event has occurred for the other client apparatuses as a transmission/reception target of the message information by analyzing the message information, and
means for generating, when it is judged that the predetermined event has occurred, the meeting member candidate information by performing a weighted random selection such that the other client apparatuses to which the predetermined event has occurred is highly weighted, to select the other client apparatuses.

11. The client apparatus according to claim 2, further comprising
an operation input means through which the first user inputs an operation,
wherein the first generation means includes means for classifying the plurality of other client apparatuses into a plurality of attributes according to the friendship degree calculated, and
wherein the fourth generation means generates the meeting member candidate information by selecting other client apparatuses having a specific attribute based on an operation input through the operation input means.

12. The client apparatus according to claim 11,
wherein the fourth generation means generates instruction information for instructing the server apparatus to adds, to the meeting member candidates, first another client apparatus having a specific attribute for second another client apparatus having a specific attribute based on the operation input through the operation input means, the second another client apparatus being selected by the fourth generation means, and
wherein the control means controls the communication means to transmit, to the server apparatus, the instruction information generated as the meeting member candidate information.

13. The client apparatus according to claim 1,
wherein the control means controls the communication means to transmit, to the server apparatus, information that indicates an intention of the first user of one of participation or nonparticipation in a meeting arranged based on the arranged meeting information received.

14. A server apparatus, comprising:
a communication means for receiving, from a plurality of client apparatuses, desired meeting information including desired meeting date/time information, desired meeting place information, and meeting member candidate information of a meeting, the desired meeting information being generated in the plurality of client apparatuses;
a first generation means for generating, based on the desired meeting information received, a plurality of optimal client apparatus groups constituted of, as elements exclusive of each other, a plurality of client apparatuses having matched desired meeting information;
a second generation means for determining an arranged date and time and an arranged meeting place for each of the plurality of optimal client apparatus groups generated, determining, as arranged meeting members, the plurality of client apparatuses belonging to the plurality of optimal client apparatus groups, and generating arranged meeting information indicating the arranged meeting date and time, the arranged meeting place, and the arranged meeting members; and
a control means for controlling the communication means to transmit the arranged meeting information generated, to the plurality of client apparatuses as the arranged meeting members.

15. The server apparatus according to claim 14,
wherein the first generation means includes
means for extracting, from client apparatuses included in the meeting member candidate information, client apparatuses having the desired meeting information and the desired meeting place information matched and a client apparatus having the meeting member candidate information generated, as a matching client apparatus group for each client apparatus, and
means for generating, in a case where client apparatuses as elements of the matching client apparatus group, extracted are regarded as a character string, an optimal client apparatus group set constituted of the optimal client apparatus groups having a minimum Levenshtein distance from a matching client apparatus group set constituted of al the matching client apparatus groups and having elements exclusive of each other.

16. The server apparatus according to claim 15,
wherein the control means controls the communication means to receives, from the plurality of client apparatuses, friendship information and instruction information, the friendship information indicating a friendship and a friendship degree between users of the plurality of client apparatuses, the instruction information indicating an instruction to add first another client apparatus with which second another client apparatus has a predetermined friendship degree as the meeting member candidate, the second another client apparatus having a predetermined friendship degree with each of client apparatuses generating the meeting member candidate information, and
wherein the first generation means adds the first another client apparatus to the meeting member candidate of each of client apparatuses based on the friendship information and the instruction information received.

17. The server apparatus according to claim 15,
wherein the first generation means encodes a predetermined client apparatus group set randomly selected from the plurality of client apparatuses to be a predetermined chromosome population, generates a chromosome population whose goodness of fit is maximum with the matching client apparatus groups by repeatedly performing a crossing-over processing, a mutation processing, and a growth and killing processing on chromosomes belonging to the chromosome population, and decodes the chromosome population, to thereby generate the optimal client apparatus group set.

18. The server apparatus according to claim 15,
wherein the desired meeting date/time information includes information on a desired meeting date, a desired meeting starting time, and a desired meeting ending time, and
wherein the second generation means calculates an average time of desired meeting starting times of client apparatuses belonging to the optimal client apparatus groups as an arranged meeting starting time, and calculates an average time of desired meeting ending times of the client apparatuses as an arranged meeting ending time.

19. The server apparatus according to claim 15,
wherein the desired meeting place information includes tolerable movement distance range information indicating a distance range capable of being tolerated by users from movement original positions of the users of the plurality of client apparatuses, and
wherein the second generation means determines, to be the arranged meeting place, a place within a predetermined distance range around a weighted center of a sum of sets of the tolerable movement distance ranges of the plurality of clients belonging to the optimal client apparatus groups.

20. The server apparatus according to claim 19,
wherein the control means controls the communication means to receive map information including information on a facility located within the predetermined distance range around the weighted center of the sum of the sets of the tolerable movement distance ranges, and
wherein the second generation means determines the facility to be the arranged meeting place based on the map information received.

21. A meeting arrangement system comprising a server apparatus and a plurality of client apparatuses,
wherein each of the plurality of client apparatuses includes
a first communication means for communicating with a server apparatus and other client apparatuses,
a first generation means for generating, based on communication history information with the plurality of other client apparatuses by the communication means, friendship information indicating a friendship between a first user of the client apparatus and each of second users of the plurality of other client apparatuses,
a storage means for storing schedule information including scheduled date/time information and scheduled place information of a scheduled event for the first user and meeting history information including date/time history information, place history information, and member history information of a meeting arranged in a past,
a second generation means for generating desired meeting date/time information of the first user based on the scheduled date, time information and the date/time history information stored,
a third generation means for generating desired meeting place information of the first user based on the scheduled place information stored, the place history information stored, and desired meeting date/time information generated,
a fourth generation means for generating meeting member candidate information indicating candidates of client apparatuses to be meeting members based on the friendship information generated, and
a first control means for controlling the first communication means to transmit, to the server apparatus, the desired meeting date/time information, the desired meeting place information, and the meeting member candidate information generated as desired meeting information, and controlling the first communication means to receive arranged meeting information arranged by the server apparatus based on the desired meeting information transmitted, and
wherein the server apparatus includes
a second communication means for receiving desired meeting information transmitted from the plurality of client apparatuses,
a fifth generation means for generating, based on the desired meeting information received, a plurality of optimal client apparatus groups constituted of, as elements exclusive of each other, a plurality of client apparatuses having matched desired meeting information,
a sixth generation means for determining an arranged date and time and an arranged meeting place for each of the plurality of optimal client apparatus groups, determining, as arranged meeting members, the plurality of client apparatuses belonging to the plurality of optimal client apparatus groups, and generating arranged meeting information indicating the arranged meeting date and time, the arranged meeting place, and the arranged meeting members, and
a second control means for controlling the communication means to transmit the arranged meeting information generated, to the plurality of client apparatuses as the arranged meeting members.

22. A meeting arrangement method using a server apparatus and a plurality of client apparatuses, comprising:
generating, based on communication history information with the plurality of other client apparatuses, friendship information indicating a friendship between a first user of the client apparatus and each of second users of the plurality of other client apparatuses;
storing schedule information including scheduled date/time information and scheduled place information of a scheduled event for the first user and meeting history information including date/time history information, place history information, and member history information of a meeting arranged in a past;
generating desired meeting date/time information of the first user based on the scheduled date/time information and the date/time history information stored;
generating desired meeting place information of the first user based on the scheduled place information stored, the place history information stored, and desired meeting date/time information generated;
generating meeting member candidate information indicating candidates of client apparatuses to be meeting members based on the friendship information generated;
transmitting, to the server apparatus, the desired meeting date/time information, the desired meeting place information, and the meeting member candidate information generated as desired meeting information;
receiving the desired meeting information transmitted from the plurality of client apparatuses;
generating, based on the desired meeting information received, a plurality of optimal client apparatus groups constituted of, as elements exclusive of each other, a plurality of client apparatuses having matched desired meeting information;
determining an arranged date and time and an arranged meeting place for each of the plurality of optimal client apparatus groups, determining, as arranged meeting members, the plurality of client apparatuses belonging to the plurality of optimal client apparatus groups, and generating arranged meeting information indicating the arranged meeting date and time, the arranged meeting place, and the arranged meeting members; and
transmitting the arranged meeting information generated, to the plurality of client apparatuses as the arranged meeting members,
the former six steps stated above being executed by the plurality of client apparatuses, the latter four steps stated above being executed by the server apparatus.

23. A client apparatus, comprising:
a communication unit capable of communicating with a server apparatus and a plurality of other client apparatuses;
a first generator to generate, based on communication history information with the plurality of other client apparatuses by the communication unit, friendship information indicating a friendship between a first user of the client apparatus and each of second users of the plurality of other client apparatuses;
a storage unit to store schedule information including scheduled date/time information and scheduled place information of a scheduled event for the first user and meeting history information including date/time history information, place history information, and member history information of a meeting arranged in a past;
a second generator to generate desired meeting date/time information of the first user based on the scheduled date/time information and the date/time history information stored;
a third generator to generate desired meeting place information of the first user based on the scheduled place information stored, the place history information stored, and desired meeting date/time information generated;
a fourth generator to generate meeting member candidate information indicating candidates of client apparatuses to be meeting members based on the friendship information generated; and
a controller to control the communication unit to transmit, to the server apparatus, the desired meeting date/time information, the desired meeting place information, and the meeting member candidate information generated as desired meeting information, and control the communication unit to receive arranged meeting information arranged by the server apparatus based on the desired meeting information transmitted.

24. A server apparatus, comprising:
a communication unit to receive, from a plurality of client apparatuses, desired meeting information including desired meeting date/time information, desired meeting place information, and meeting member candidate information of a meeting, the desired meeting information being generated in the plurality of client apparatuses;
a first generator to generate, based on the desired meeting information received, a plurality of optimal client apparatus groups constituted of, as elements exclusive of each other, a plurality of client apparatuses having matched desired meeting information;
a second generator to determine an arranged date and time and an arranged meeting place for each of the plurality of optimal client apparatus groups, determine, as arranged meeting members, the plurality of client apparatuses belonging to the plurality of optimal client apparatus groups, and generate arranged meeting information indicating the arranged meeting date and time, the arranged meeting place, and the arranged meeting members; and
a controller to control the communication unit to transmit the arranged meeting information generated, to the plurality of client apparatuses as the arranged meeting members.
